(19) United States
(12) Patent Application Publication
(10) Pub. No.: US 2024/0286262 A1
(43) Pub. Date: Aug. 29, 2024

(54) ACCESSORY ADAPTERS FOR POWER TOOLS

(71) Applicant: MILWAUKEE ELECTRIC TOOL CORPORATION, Brookfield, WI (US)

(72) Inventors: Julian L. Kinneavy, Wauwatosa, WI (US); Carter A. Gibson, Wauwatosa, WI (US); Scott T. Moeller, Richfield, WI (US); Dalton Fitch, Avon, IN (US)

(21) Appl. No.: 18/588,525

(22) Filed: Feb. 27, 2024

Related U.S. Application Data
(60) Provisional application No. 63/487,505, filed on Feb. 28, 2023.

(51) Int. Cl. B25F 3/00; B25B 21/00; B25B 23/00

(52) U.S. Cl. CPC B25F 3/00; B25B 21/007; B25B 23/0028

(57) ABSTRACT

A device may include a housing. A device may include a shank supported by the housing, the shank extending along a first axis and including a tool coupling portion configured to couple to the tool. A device may include a tool bit adapter supported by the housing along a second axis, the tool bit adapter being pivotable relative to the housing such that the second axis is disposed at a plurality of angles relative to the first axis. A device may include a transmission assembly positioned within the housing, the transmission assembly configured to convert an input torque about the first axis from the tool to an output torque about the second axis acting on the tool bit.

### CROSS-REFERENCE TO RELATED APPLICATIONS

This application claims priority to U.S. Provisional Patent Application No. 63/487,505, filed Feb. 28, 2023, the entire contents of which is incorporated by reference herein.

### FIELD OF INVENTION

The present invention relates to accessory tools for power tools, and more particularly to accessory tool adapters for power tools.

### SUMMARY

In some aspects, the techniques described herein relate to an angled adapter for coupling a tool bit to a tool, the angled adapter including: a housing; a shank supported by the housing, the shank extending along a first axis and including a tool coupling portion configured to couple to the tool; a tool bit adapter supported by the housing along a second axis, the tool bit adapter being pivotable relative to the housing such that the second axis is disposed at a plurality of angles relative to the first axis; and a transmission assembly positioned within the housing, the transmission assembly configured to convert an input torque about the first axis from the tool to an output torque about the second axis acting on the tool bit.

In some aspects, the techniques described herein relate to an angled adapter for coupling a tool bit to a tool, the angled adapter including: a housing including a first section and a second section; a transmission assembly positioned within the housing, the transmission assembly configured to convert an input torque about a first axis from the tool to an output torque about a second axis acting on the tool bit, the second axis disposed at an angle relative to the first axis; a shank supported by the housing, the shank extending along the first axis and including a tool coupling portion configured to couple to the tool; and a handle assembly coupled to the housing.

In some aspects, the techniques described herein relate to an angled adapter for coupling a tool bit to a tool, the angled adapter including: a housing including a first section and a second section; a transmission assembly positioned within the housing, the transmission assembly configured to convert an input torque about a first axis from the tool to an output torque about a second axis acting on the tool bit, the second axis disposed at an angle relative to the first axis; a shank supported by the housing, the shank extending along the first axis and including a tool coupling portion configured to couple to the tool; and a lighting element supported by the housing.

### BRIEF DESCRIPTION OF THE DRAWINGS

FIG. 1 illustrates a perspective view of an angled adapter.

FIG. 2 illustrates another perspective view of the angled adapter of FIG. 1.

FIG. 3A illustrates a transmission assembly for the angled adapter of FIG. 1 according to an embodiment of the invention.

FIG. 3B illustrates an alternative transmission assembly for the angled adapter of FIG. 1 according to an embodiment of the invention.

FIG. 3C illustrates another alternative transmission assembly for the angled adapter of FIG. 1 according to an embodiment of the invention.

FIG. 3D illustrates another alternative transmission assembly for the angled adapter of FIG. 1 according to an embodiment of the invention.

FIG. 3E illustrates another alternative transmission assembly for the angled adapter of FIG. 1 according to an embodiment of the invention.

FIG. 4 illustrates a perspective view of an angled adapter including a handle assembly.

FIG. 5 illustrates a perspective view of an angled adapter including a lighting element according to an embodiment of the invention.

FIG. 6 illustrates a perspective view of an angled adapter including a lighting element according to an embodiment of the invention.

FIG. 7 illustrates a side view of an angled adapter including a passthrough aperture according to an embodiment of the invention.

FIG. 8 illustrates a schematic view of a self-feeding tool bit mechanism for the angled adapter of FIG. 7.

FIG. 9 illustrates a side view of an angled adapter including a telescoping housing in a contracted state according to an embodiment of the invention.

FIG. 10 illustrates a side view of the angled adapter of FIG. 9 in an extended state.

FIG. 11 illustrates a side view of an angled adapter including a grip collar according to an embodiment of the invention.

FIG. 12 includes various views of an angled adapter including a tool bit capture mechanism according to an embodiment of the invention.

FIG. 13 illustrates a modular, angled adapter according to an embodiment of the invention, the modular, angled adapter including a plurality of shell bodies is a disassembled state.

FIG. 14 illustrates a perspective view of the modular, angled adapter of FIG. 13 in an assembled state.

FIG. 15 illustrates another perspective view of the modular, angled adapter of FIG. 13 training the assembled state.

FIG. 16 illustrates an angled adapter and a plurality of handles for use with the angled adapter according to an embodiment of the invention.

FIG. 17 illustrates a perspective view of an angled adapter including a first tool mount according to an embodiment of the invention.

FIG. 18 illustrates a perspective view of an angled adapter including a second tool mount according to an embodiment of the invention.

FIG. 19 illustrates a perspective view of an angled adapter including a housing, a transmission assembly, a lock assembly, and a shield.

FIG. 20 illustrates a side view of the angled adapter of FIG. 19 with a portion of the housing removed.

FIG. 21 illustrates a detailed view of the transmission assembly and the lock assembly of FIG. 19.

FIG. 22 illustrates a cross-sectional view of the lock assembly.

FIG. 23A illustrates a perspective view of a tool bit adapter for use with FIG. 19.

FIG. 23B illustrates a cross-sectional view of the tool bit adapter of FIG. 23A along the line 23B-23B of FIG. 23A.

FIG. 24A illustrates an end view of the angled adapter of FIG. 19.

FIG. 24B illustrates an end view of angled adapter that is similar to that of FIG. 19 but with a different size and a different shield.

FIG. 25 illustrates a side view of an angled adapter including a transmission assembly and a handle assembly.

FIG. 26 illustrates a perspective view of the angled adapter of FIG. 25 and an actuator of a lock assembly.

FIG. 27 illustrates the transmission assembly FIG. 25, the lock assembly of FIG. 26, and the tool bit adapter of FIG. 24A.

FIG. 28 illustrates a detailed view of a portion of the lock assembly of FIG. 27.

FIG. 29 illustrates a perspective view of a portion of the lock assembly of FIG. 27.

FIG. 30 is another lock assembly for use with the angle adapter of FIG. 25.

FIG. 31 illustrates a detailed view of the handle assembly of FIG. 25.

FIG. 32 illustrates a handle of FIG. 25.

FIG. 33 illustrates a detailed view of a clamp of the handle assembly of FIG. 25.

FIG. 34 illustrates a cross-sectional view of the clamp and handle of the handle assembly of FIG. 25 along line 34-34 of FIG. 33.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Described herein is an angled adapter for coupling a tool bit to a tool. The angled adapter includes a housing and a transmission assembly positioned within the housing. The housing includes a first section defining a first axis, and a second section defining a second axis. The transmission assembly is configured to convert an input torque about the first axis from the tool to an output torque about the second axis acting on the tool bit. The second section of the housing is pivotable relative to the first section at a plurality of angles. The transmission assembly comprises one or more bevel gears to transmit torque from the tool to the tool bit. The plurality of angles between the housing first section and the housing second section better accommodates positioning the power tool relative to a workpiece.

Further, the angled adapter comprises a handle assembly to improve stability of the angled adapter during power tool operation. The handle assembly further allows for an additional location (i.e., two locations, rather than one location) where the power tool can be grasped to improve stability between the power tool and the workpiece. The angled adapter further comprises a lighting element to better illuminate the workpiece during power tool operation.

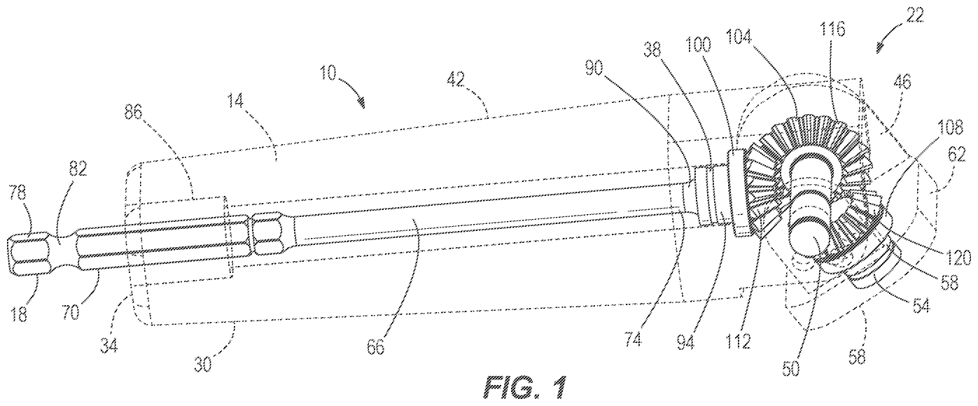

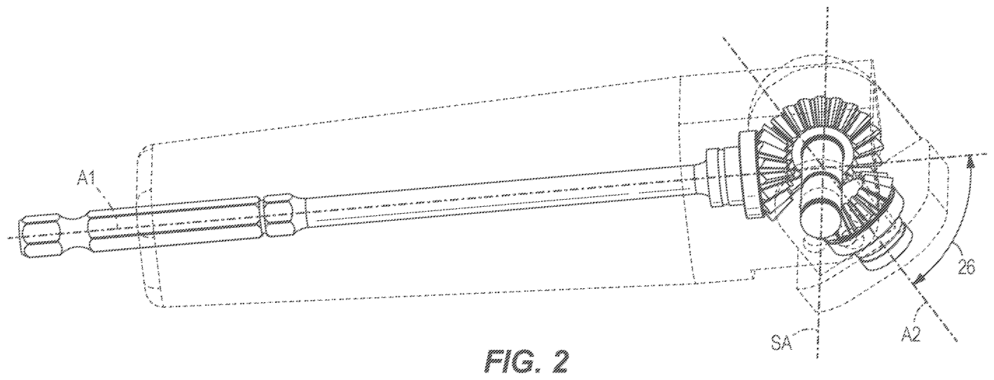

Referring to the drawings, FIGS. 1 and 2 illustrate an angled adapter 10 (hereafter “the adapter 10”) configured to operatively couple to a tool (e.g., a power tool, such as a drill/driver) and a tool bit (not shown). The adapter 10 includes a housing 14 supporting a shank 18 and a transmission assembly 22. The shank 18 is driven to rotate about a first axis A1 (FIG. 2) by a torque applied by the tool. The shank 18 is operatively coupled to the transmission assembly 22. The transmission assembly 22 converts the input torque about the first axis A1 to an output torque acting on the tool bit to drive the tool bit to rotate about a second axis A2 (FIG. 2) that is disposed at an angle 26 relative to the first axis A1.

With continued reference to FIGS. 1 and 2, the housing 14 includes a first section 30 including a shank receiving aperture 34 at a first end, and a first transmission aperture 38 at a second end. The first section 30 of the housing 14 defines a cavity 42 between the first end and the second end. The second end of the first section 30 is coupled to a second section 46 of the housing 14. The first section 30 and the second section 46 can be coupled together via a shaft 50 extending along a shaft axis SA (FIG. 2). The first section 30 of the housing 14 defines the first axis A1, and the second section 46 of the housing 14 defines the second axis A2.

The shaft 50 allows the second section 46 to pivot relative to the first section 30 at a plurality of angles 26. The plurality of angles 26 can range between approximately 75-180 degrees. More specifically, the plurality of angles 26 can be approximately 90-105 degrees. The plurality of angles 26 can be approximately 120-180 degrees. In one example, the angle 26 can be approximately 90 degrees. In another example, the angle 26 can be approximately 105 degrees. The housing 14 being pivotable (i.e., second section 46 pivots relative to the first section 30) allows for a greater number of angles in relation to the workpiece thereby better accommodating the positioning of the power tool relative to the workpiece.

With continued reference to FIG. 1, the second section 46 of the housing 14 includes a tool bit adapter aperture 54 disposed at an angle relative to the first transmission aperture 38. In other words, a plane defined by the first transmission aperture 38 and extending along the first axis A1 can be angled (e.g., acute, perpendicular, obtuse) to a plane defined by the tool bit adapter aperture 54 and extending along the second axis A2. The tool bit adapter aperture 54 is disposed in facing relation to a tool bit aperture 58 defined by a third section 62 of the housing 14. The second section 46 and the third section 62 of the housing 14 can be secured together with a set of fasteners.

As shown in FIG. 1, the shank 18 can include an intermediate portion 66 extending between a tool coupling portion 70 and a transmission coupling portion 74. The tool coupling portion 70 of the shank 18 can be configured to couple with the tool. The transmission coupling portion 74 of the shank 18 can be configured to couple with the transmission assembly 22. In the illustrated embodiment, the intermediate portion 66, the tool coupling portion 70, and the transmission coupling portion 74 can be integrally formed as a single piece. In other embodiments, the shank portions 66, 70, 74 can be formed as separate pieces that are permanently or releasably secured together.

With continued reference to FIG. 1, the tool coupling portion 70 includes a body 78 and a groove 82. The body 78 can include a hexagonal cross section. At least a portion of the body 78 can be engageable with the tool to rotationally couple the shank 18 to the tool. The groove 82 receives a retention member of the tool (e.g., a detent ball, a clip, etc.) to maintain engagement between the shank 18 and the tool. Another portion of the body 78 of the tool coupling portion 70 extends into the first section 30 of the housing 14 and is rotationally supported by a first input bearing 86.

The tool coupling portion 70 can comprise a shape including an outer dimension. In some embodiments, the outer dimension of the tool coupling portion 70 can refer to a width between two opposite sides, for example, but not limited to, of a hexagon, square, or rectangle shape. In other embodiments, the outer dimension of the tool coupling portion 70 can refer to a diameter of a cylindrical shape. The intermediate portion 66 of the shank 18 can comprise a diameter less than the outer dimension of the tool coupling portion 70.

The transmission coupling portion 74 includes a body 90. The body 90 of the transmission coupling portion 74 can comprise a hexagonal cross section. The body 90 of the transmission coupling portion 74 is operatively engageable with the transmission assembly 22. The transmission coupling portion 74 is rotationally supported by a second input bearing 94 such that the shank 18 is further rotationally supported within the housing 14.

The transmission assembly of the angled adapter 10 can further comprise one or more gears configured to convert an input torque about the first axis A1 from the tool to an output torque about the second axis A2 acting on the tool bit. The second axis A2 can be disposed at a plurality of angles relative to the first axis A1. The shank 18 is operatively coupled to the transmission assembly. The tool bit is operatively coupled to the transmission assembly. Described below are various embodiments of transmission assemblies comprising one or more gears.

With continued reference to FIG. 1, the transmission assembly 22 includes a first bevel gear 100 coupled to a second bevel gear 104, and a third bevel gear 108 coupled to the second bevel gear 104. The first bevel gear 100 can be attached to the shank 18. The second bevel gear 104 can be coaxial with the shaft axis SA of the shaft 50. The third bevel gear 108 can be supported by the second section 46 of the housing 14. The first bevel gear 100 rotates about the first axis A1. The second bevel gear 104 rotates about the shaft axis SA of the shaft 50 (FIG. 2), wherein the shaft axis SA can be angled (e.g., perpendicular) relative to the first axis A1. The third bevel gear 108 rotates about the second axis A2.

As shown in FIG. 1, the first bevel gear 100 can include a plurality of teeth 112. The second bevel gear 104 can include a plurality of teeth 116. The third bevel gear 108 can include a plurality of teeth 120. The first bevel gear 100 can be rotationally supported by the second input bearing 94. The second bevel gear 104 can be rotationally supported by a bearing (not shown) disposed within the second section 46 of the housing 14. The third bevel gear 108 can be rotationally supported by an output bearing (not shown) coupled between the second section 46 and third section 62 of the housing 14. The teeth 116 of the second gear 104 can intermesh with the teeth 112 of the first bevel gear 100 and the teeth 120 of the third bevel gear 108. When assembled, the teeth 112 of the first bevel gear 100, the teeth 116 of the second bevel gear 104, and the teeth 120 of the third bevel gear 108 can intermesh together such that rotation of the first bevel gear 100 about the first axis A1 results in rotation of the third bevel gear 108 about the second axis A2.

In operation, a torque is applied by the tool to the tool coupling portion 70 of the shank 18 to drive rotation of the shank 18. The rotation of the shank 18 drives rotation of the first bevel gear 100 about the first axis A1 via the operative engagement between the body 90 of the transmission coupling portion 74 and a hexagonal bore in the first bevel gear 100. Concurrently, the third bevel gear 108 is driven to rotate about the second axis A2 via engagement between the teeth 112 of the first bevel gear 100, the teeth 116 of the second bevel gear 104, and teeth 120 of the third bevel gear 108. A tool bit is retained within a bore of the third bevel gear 108 for rotation with the third bevel gear 108. Accordingly, the angled adapter 10 converts the torque applied to the shank 18 to generate rotation of the shank 18 about the first axis A1 to rotation of the tool bit about the second axis A2.

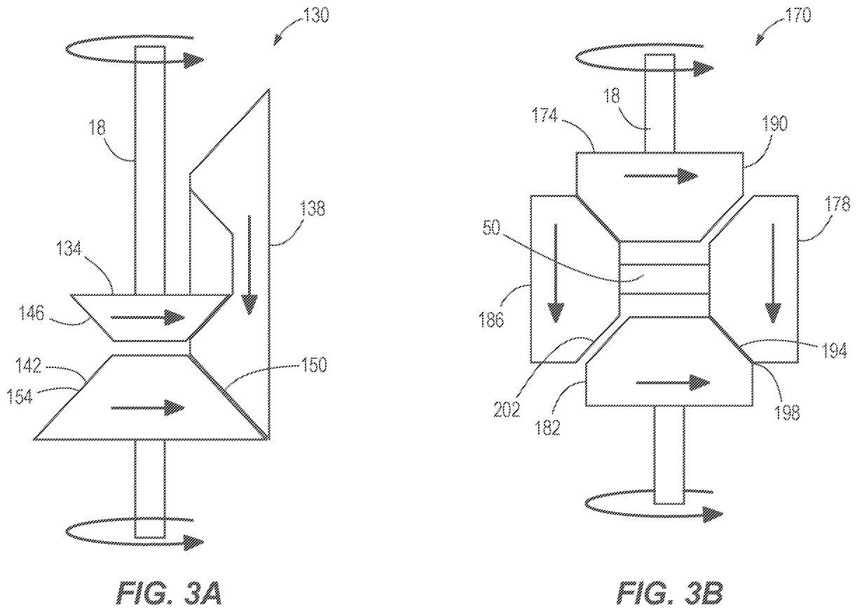

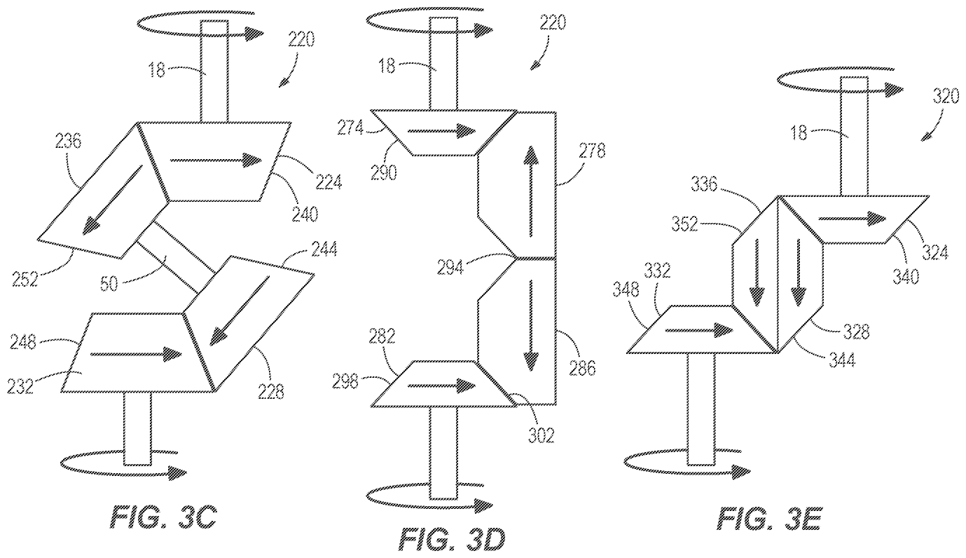

FIG. 3A illustrates a transmission assembly 130 according to another embodiment of the invention. As illustrated in FIG. 3A, the transmission assembly includes a first bevel gear 134 coupled to a second bevel gear 138, and a third bevel gear 142 coupled to the second bevel gear 138. The first bevel gear 134 can be attached to the shank 18. The second bevel gear 138 can be disposed in a recess defined by the second section 46 of the housing 14. The third bevel gear 142 can be supported by the second section 46 of the housing 14. The first bevel gear 134 rotates about the first axis A1. The third bevel gear 142 rotates about the second axis A2.

With continued reference to FIG. 3A, the first bevel gear 134 can include a plurality of teeth 146. The second bevel gear 138 can include a plurality of teeth 150. The third bevel gear 142 can include a plurality of teeth 154. The first bevel gear 134 can be rotationally supported by an input bearing (not shown). The second bevel gear 138 can be rotationally supported by a bearing (not shown) disposed within the second section 46 of the housing 14. The third bevel gear 142 can be rotationally supported by an output bearing (not shown) coupled between the second section 46 and third section 62 of the housing 14.

The first bevel gear 134 can comprise a first diameter. The second bevel gear 138 can comprise a second diameter greater than the first diameter. The teeth 150 of the second bevel gear 138 can intermesh with the teeth 146 of the first bevel gear 134 and the teeth 154 of the third bevel gear 142. In particular, the teeth 146 of the first bevel gear 134 can intermesh with teeth on an inner surface of the second bevel gear 138 that define a pocket (FIG. 3A), while the teeth 154 of the third bevel gear 142 can intermesh with teeth on an outer surface of the bevel gear 138. When assembled, the teeth 146 of the first bevel gear 134, the teeth 150 of the second bevel gear 138, and the teeth 154 of the third bevel gear 142 can intermesh together such that rotation of the first bevel gear 134 about the first axis A1 results in rotation of the third bevel gear 142 about the second axis A2. The arrangement of the bevel gears results in the first and third bevel gears 134, 142 rotating in the same direction.

In operation, a torque is applied by the tool to the tool coupling portion 70 of the shank 18 to drive rotation of the shank 18. The rotation of the shank 18 drives rotation of the first bevel gear 134 about the first axis A1 via the operative engagement between the body 90 of the transmission coupling portion 74 and a hexagonal bore in the first bevel gear 134. Concurrently, the third bevel gear 142 is driven to rotate about the second axis A2 via engagement between the teeth 146 of the first bevel gear 134, the teeth 150 of the second bevel gear 138, and teeth 154 of the third bevel gear 142. A tool bit is retained within a bore of the third bevel gear 142 for rotation with the third bevel gear 142. Accordingly, the angled adapter 10 converts the torque applied to the shank 18 to generate rotation of the shank 18 about the first axis A1 to rotation of the tool bit about the second axis A2.

FIG. 3B illustrates a transmission assembly 170 according to another embodiment of the invention. As illustrated in FIG. 3B, the transmission assembly 170 includes a first bevel gear 174, a second bevel gear 178, a third bevel gear 182, and a fourth bevel gear 186. The first bevel gear 174 is coupled to the fourth bevel gear 186. The second bevel gear 178 is coupled to the third bevel gear 182. The second bevel gear 178 and the fourth bevel gear 186 are also rotatably coupled together by the shaft 50. The first bevel gear 174 can be attached to the shank 18. The second bevel gear 178 can be supported by the second section 46 of the housing 14. The third bevel gear 182 can be supported by the second section 42 of the housing 14. The fourth bevel gear 186 can be supported by the second section 42 of the housing 14. The second bevel gear 178 can be adjacent a first end of the shaft 50. The fourth bevel gear 186 can be adjacent a second end of the shaft 50 opposite the first end of the shaft 50. The first bevel gear 174 rotates about the first axis A1. The second bevel gear 178 and the fourth bevel gear 186 can be coaxial with the shaft axis SA of the shaft 50. The third bevel gear 182 rotates about the second axis A2.

With continued to FIG. 3B, the first bevel gear 174 can include a plurality of teeth 190. The second bevel gear 178 can include a plurality of teeth 194. The third bevel gear 182 can include a plurality of teeth 198. The fourth bevel gear 186 can include a plurality of teeth 202. The first bevel gear 174 can be rotationally supported by an input bearing (not shown). The second bevel gear 178 can be rotationally supported by a bearing (not shown) disposed within the second section 46 of the housing 14. The third bevel gear 182 is rotationally supported by an output bearing (not shown) coupled between the second section 46 and third section 62 of the housing 14. The fourth bevel gear 186 can be supported by a bearing (not shown) disposed within the second section 46 of the housing 14.

As shown in FIG. 3B, the teeth 202 of the fourth bevel gear 186 can intermesh with the teeth 190 of the first bevel gear 174 and the teeth 198 of the third bevel gear 182. The second bevel gear 178 and the fourth bevel gear 186 can rotate in the same direction. For example, the shaft 50 can transmit rotation of the fourth bevel gear 186 to the second bevel gear 178. The first bevel gear 174 and the third bevel gear 182 can rotate in the same direction. When assembled, the teeth 190 of the first bevel gear 174, the teeth 194 of the second bevel gear 178, the teeth 198 of the third bevel gear 182, and the teeth 202 of the fourth bevel gear 186 can intermesh together such that rotation of the first bevel gear 174 about the first axis A1 results in rotation of the third bevel gear 182 about the second axis A2.

In operation, a torque is applied by the tool to the tool coupling portion 70 of the shank 18 to drive rotation of the shank 18. The rotation of the shank 18 drives rotation of the first bevel gear 174 about the first axis A1 via the operative engagement between the body 90 of the transmission coupling portion 74 and a hexagonal bore in the first bevel gear 174. Concurrently, the third bevel gear 182 is driven to rotate about the second axis A2 via engagement between the teeth 190 of the first bevel gear 174, the teeth 194 of the second bevel gear 178, teeth 198 of the third bevel gear 182, and teeth 202 of the fourth bevel gear 186. A tool bit is retained within a bore of the third bevel gear 182 for rotation with the third bevel gear 182. Accordingly, the angled adapter 10 converts the torque applied to the shank 18 to generate rotation of the shank 18 about the first axis A1 to rotation of the tool bit about the second axis A2.

FIG. 3C illustrates a transmission assembly 220 according to another embodiment of the invention. As illustrated in FIG. 3C, the transmission assembly 220 includes a first bevel gear 224, a second bevel gear 228, a third bevel gear 232, and a fourth bevel gear 236. The first bevel gear 224 is coupled to the fourth bevel gear 236, and the second bevel gear 228 is coupled to the third bevel gear 232. The first bevel gear 224 can be attached to the shank 18. The second bevel gear 228 can be supported by the second section 46 of the housing 14. The third bevel gear 232 can be supported by the second section 46 of the housing 14. The fourth bevel gear 236 can be supported by the second section 46 of the housing 14. The second bevel gear 228 can be adjacent a first end of the shaft 50 and arranged to be coaxial with the shaft axis SA. The fourth bevel gear 236 can be adjacent a second end of the shaft 50 opposite the first end and arranged to be coaxial with the shaft axis SA. As illustrated in FIG. 3C, the shaft 50 can be angled with respect to the shank 18 such that the shaft axis SA can be angled with respect to the first axis A1. The first bevel gear 224 rotates about the first axis A1. The third bevel gear 232 rotates about the second axis A2.

With continued reference to FIG. 3C, the first bevel gear 224 can include a plurality of teeth 240. The second bevel gear 228 can include a plurality of teeth 244. The third bevel gear 232 can include a plurality of teeth 248. The fourth bevel gear 236 can include a plurality of teeth 252. The first bevel gear 224 can be rotationally supported by an input bearing. The second bevel gear 228 can be rotationally supported by a bearing (not shown) disposed within the second section 46 of the housing 14. The third bevel gear 232 can be rotationally supported by an output bearing (not shown) coupled between the second section 46 and third section 62 of the housing 14. The fourth bevel gear 236 can be supported by a bearing (not shown) disposed within the second section 46 of the housing 14.

As shown in FIG. 3C, the teeth 252 of the fourth bevel gear 236 can intermesh with the teeth 240 of the first bevel gear 224, but not the teeth 248 of the third bevel gear 232. The teeth 244 of the second bevel gear 278 can intermesh with the teeth 248 of the third bevel gear 232, but not the teeth 240 of the first bevel gear 224. The second bevel gear 228 and the fourth bevel gear 236 can rotate in the same direction. For example, the shaft 50 can transmit rotation of the fourth bevel gear 236 to the second bevel gear 228. The first bevel gear 224 and the third bevel gear 232 can rotate in the same direction. When assembled, the teeth 240 of the first bevel gear 224, the teeth 244 of the second bevel gear 228, the teeth 248 of the third bevel gear 232, and the teeth 252 of the fourth bevel gear 236 can intermesh together such that rotation of the first bevel gear 224 about the first axis A1 results in rotation of the third bevel gear 232 about the second axis A2.

In operation, a torque is applied by the tool to the tool coupling portion 70 of the shank 18 to drive rotation of the shank 18. The rotation of the shank 18 drives rotation of the first bevel gear 224 about the first axis A1 via the operative engagement between the body 90 of the transmission coupling portion 74 and a hexagonal bore in the first bevel gear 224. Concurrently, the third bevel gear 232 is driven to rotate about the second axis A2 via engagement between the teeth 240 of the first bevel gear 224, the teeth 244 of the second bevel gear 228, teeth 248 of the third bevel gear 232, and teeth 252 of the fourth bevel gear 236. A tool bit is retained within a bore of the third bevel gear 232 for rotation with the third bevel gear 232. Accordingly, the angled adapter 10 converts the torque applied to the shank 18 to generate rotation of the shank 18 about the first axis A1 to rotation of the tool bit about the second axis A2.

FIG. 3D illustrates a transmission assembly 270 according to another embodiment of the invention. As illustrated in FIG. 3D, the transmission assembly 270 includes a first bevel gear 274, a second bevel gear 278, a third bevel gear 282, and a fourth bevel gear 286. The first bevel gear 274 is coupled to the second bevel gear 278, the second bevel gear 278 is coupled to the fourth bevel gear 286, and the fourth bevel gear 286 is coupled to the third bevel gear 282. The first bevel gear 274 can be attached to the shank 18. The second bevel gear 278 can be supported by the second section 46 of the housing 14. The third bevel gear 282 can be supported by the second section 46 of the housing 14. The fourth bevel gear 286 can be supported by the second section 46 of the housing 14. The fourth bevel gear 286 and the second bevel gear 278 can be adjacent each other within the bevel gear configuration. The fourth bevel gear 286 and the second bevel gear 278 can be on the same side of second section 46 of housing 14. The first bevel gear 274 rotates about the first axis A1. The third bevel gear 282 rotates about the second axis A2.

With continued reference to FIG. 3D, the first bevel gear 274 can include a plurality of teeth 290. The second bevel gear 278 can include a plurality of teeth 294. The third bevel gear 282 can include a plurality of teeth 298. The fourth bevel gear 286 can include a plurality of teeth 302. The first bevel gear 274 can be rotationally supported by an input bearing. The second bevel gear 278 can be rotationally supported by a bearing (not shown) disposed within the second section 46 of the housing 14. The third bevel gear 282 can be rotationally supported by an output bearing (not shown) coupled between the second section 46 and third section 62 of the housing 14. The fourth bevel gear 286 can be supported by a bearing (not shown) disposed within the second section 46 of the housing 14.

As shown in FIG. 3D, the teeth 290 of the first bevel gear 274 can intermesh with the teeth 294 of the second bevel gear 278. The teeth 302 of the fourth bevel gear 286 can intermesh with the teeth 294 of the second bevel gear 278 and the teeth 298 of the third bevel gear 282. During operation of the transmission assembly 270, the second bevel gear 278 and the fourth bevel gear 286 can rotate in opposite directions. The first bevel gear 274 and the third bevel gear 282 can rotate in the same direction. When assembled, the teeth 290 of the first bevel gear 274, the teeth 294 of the second bevel gear 278, the teeth 298 of the third bevel gear 282, and the teeth 302 of the fourth bevel gear 286 can intermesh together such that rotation of the first bevel gear 274 about the first axis A1 results in rotation of the third bevel gear 282 about the second axis A2.

In operation, a torque is applied by the tool to the tool coupling portion 70 of the shank 18 to drive rotation of the shank 18. The rotation of the shank 18 drives rotation of the first bevel gear 274 about the first axis A1 via the operative engagement between the body 90 of the transmission coupling portion 74 and a hexagonal bore in the first bevel gear 274. Concurrently, the third bevel gear 282 is driven to rotate about the second axis A2 via engagement between the teeth 290 of the first bevel gear 274, the teeth 294 of the second bevel gear 278, the teeth 298 of the third bevel gear 282, and the teeth 302 of fourth bevel gear 286. A tool bit is retained within a bore (not shown) of the third bevel gear 282 for rotation with the third bevel gear 282. Accordingly, the angled adapter 10 converts the torque applied to the shank 18 to generate rotation of the shank 18 about the first axis A1 to rotation of the tool bit about the second axis A2.

FIG. 3E illustrates a transmission assembly 320 according to another embodiment of the invention. As illustrated in FIG. 3E, the transmission assembly 320 includes a first bevel gear 324, a second bevel gear 328, a third bevel gear 332, and a fourth bevel gear 336. The first bevel gear 324 is coupled to the second bevel gear 328, and the fourth bevel gear 336 is coupled to the third bevel gear 332. The first bevel gear 324 can be attached to the shank 18. The second bevel gear 328 can be supported by the second section 46 of the housing 14. The third bevel gear 332 can be supported by the second section 46 of the housing 14. The fourth bevel gear 336 can be supported by the second section 46 of the housing 14. The fourth bevel gear 336 and the second bevel gear 328 can be adjacent each other within the second section 46 of housing 14. In other words, a side of the second bevel gear 328 can be attached to a side of the fourth bevel gear 336 such that rotation of the second bevel gear 328 is transmitted to the fourth bevel gear 336. The first bevel gear 324 rotates about the first axis A1. The third bevel gear 332 rotates about the second axis A2.

With continued reference to FIG. 3E, the first bevel gear 324 can include a plurality of teeth 340. The second bevel gear 328 can include a plurality of teeth 344. The third bevel gear 332 can include a plurality of teeth 348. The fourth bevel gear 336 can include a plurality of teeth 352. The first bevel gear 324 can be rotationally supported by an input bearing. The second bevel gear 328 can be rotationally supported by a bearing (not shown) disposed within the second section 46 of the housing 14. The third bevel gear 332 can be rotationally supported by an output bearing (not shown) coupled between the second section 46 and third section 62 of the housing 14. The fourth bevel gear 336 can be supported by a bearing (not shown) disposed within the second section 46 of the housing 14.

During operation, the fourth bevel gear 336 and the second bevel gear 328 can rotate in the same direction. The first bevel gear 324 and the third bevel gear 332 can rotate in the same direction. The teeth 344 of the second bevel gear 328 can intermesh with the teeth 340 of the first bevel gear 324. The teeth 352 of the fourth bevel gear 336 can intermesh with the teeth 348 of the third bevel gear 332. When assembled, the teeth 340 of the first bevel gear 324, the teeth 344 of the second bevel gear 328, the teeth 348 of the third bevel gear 332, and the teeth 352 of the fourth bevel gear 336 can intermesh together such that rotation of the first bevel gear 324 about the first axis A1 results in rotation of the third bevel gear 332 about the second axis A2.

In operation, a torque is applied by the tool to the tool coupling portion 70 of the shank 18 to drive rotation of the shank 18. The rotation of the shank 18 drives rotation of the first bevel gear 324 about the first axis A1 via the operative engagement between the body 90 of the transmission coupling portion 74 and a hexagonal bore in the first bevel gear 324. Concurrently, the third bevel gear 332 is driven to rotate about the second axis A2 via engagement between the teeth 340 of the first bevel gear 324, the teeth 344 of the second bevel gear 328, teeth 348 of the third bevel gear 332, and the teeth 352 of fourth bevel gear 336. A tool bit is retained within a bore (not shown) of the third bevel gear 332 for rotation with the third bevel gear 332. Accordingly, the angled adapter 10 converts the torque applied to the shank 18 to generate rotation of the shank 18 about the first axis A1 to rotation of the tool bit about the second axis A2.

In other embodiments, the transmission assembly of the angled adapter can comprise other energy transfer methods to convert the input torque about the first axis A1 from the tool to the output torque about the second axis A2 acting on the tool bit. The second axis A2 can be disposed at a plurality of angles relative to the first axis A1.

In one example, the transmission assembly can comprise a pivoting constant velocity joint (hereafter “the CV joint”). The CV joint can include one or more shafts, or one or more bearings. The CV joint can comprise a hinged element (e.g., ball or pivotable links) that attaches to both the shank 18 and the tool bit. The hinged element allows the tool bit to pivot at a plurality of angles relative to the first section 30 of the housing 14. The CV joint allows the shank 18 to transmit power to the tool bit at a variable angle and constant rotational speed without any increase in friction.

In another example, the transmission assembly can comprise a torsion spring. The torsion spring can attach to the shank 18 and the tool bit. The torsion spring can be disposed within the second section 46 of the housing 14. The torsion spring allows the tool bit to pivot at a plurality of angles relative to the first section 30 of the housing 14.

In another example, the transmission assembly can comprise a universal joint. The universal joint can comprise a first hinge, a second hinge, and a cross shaft. The first hinge and the second hinge can comprise a shape such as a fork shape, U shape, or rectangular U shape. The universal joint can be disposed within the second section 46 of the housing 14. The first hinge can be attached to the shank 18. The second hinge can be attached to the tool bit. The cross shaft connects the first hinge and the second hinge together. The universal joint allows the tool bit to pivot at a plurality of angles relative to the first section 30 of the housing 14.

In another example, the transmission assembly can comprise a double universal joint. The double universal joint can comprise a first link member, a second link member, and a base member. The double universal joint can be disposed within the second section 46 of the housing 14. The first link member and the second link member can be coupled to the base member. The first link member can be attached to the shank 18. The second link member can be attached to the tool bit. The double universal joint allows the tool bit to pivot at a plurality of angles relative to the first section 30 of the housing 14.

In another example, the transmission assembly can comprise one or more hemispherical gears. The one or more hemispherical gears can comprise a first hemispherical gear and a second hemispherical gear. The one or more hemispherical gears can be disposed within the second section 46 of the housing 14. The first hemispherical gear can be attached to the shank 18. The second hemispherical gear can be attached to the tool bit. The first hemispherical gear and the second hemispherical gear can intermesh together to pivot the tool bit at a plurality of angles relative to the first section 30 of the housing 14.

In another example still, the transmission assembly can further comprise one or more hinged gears. The one or more hinged gears can comprise a first hinged gear and a second hinged gear. The one or more hinged gears can be disposed within the second section 46 of the housing 14. The first hinged gear can be attached to the shank 18. The second hinged gear can be attached to the tool bit. The first hinged gear and the second hinged gear can intermesh together to pivot the tool bit at a plurality of angles relative to the first section 30 of the housing 14.

The angled adapter comprising the housing including a pivoting feature and the transmission assembly as described above can further comprise a handle assembly. The handle assembly improves the stability of the angled adapter and the power tool relative to the workpiece. The handle assembly allows for an additional location (i.e., two locations rather than one location) for an operator to grasp the power tool to improve the stability of the power tool relative to the workpiece.

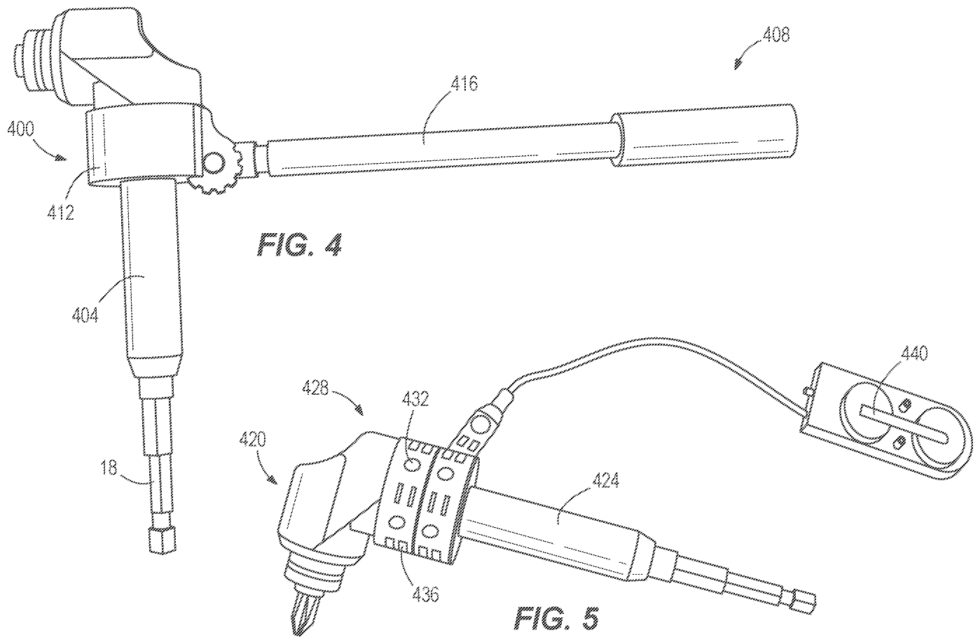

FIG. 4 illustrates a top perspective view of an angled adapter 400 (hereafter “the adapter 400”) including a housing 404 and a handle assembly 408 according to an embodiment of the invention. The angled adapter 400 can include the pivoting feature (i.e., second section of the housing pivots relative to the first section of the housing) as described above for the adapter 10. In some embodiments, the adapter 400 may not include the pivoting feature such that the second section of the housing 404 remains stationary or is fixed relative to the first section of the housing 404. The adapter 400 can be similar to the adapter 10 described above, but further comprises the handle assembly 408. The handle assembly 408 is configured to be coupled to the housing 404 of the adapter 400.

As shown in FIG. 4, the handle assembly 408 can comprise a collar 412 and an arm 416. The collar 412 may be removably coupled to the housing 404 or may be permanently fixed to the housing 404. The arm 416 extends from the collar 412. The arm 416 can be extendable to increase a length of the handle assembly 408. For example, in some embodiments, the arm 416 can be a telescoping arm. Extending the length of the arm 416 allows for greater flexibility for the operator to stabilize the power tool relative to the workpiece. The arm 416 can pivot at a plurality of angles relative to the adapter 400 or the collar 412. In the illustrated embodiment, the arm 416 can pivot about an axis that is perpendicular to both a first longitudinal axis of the first section of the housing 404 and a second longitudinal axis of the second section of the housing 404. Pivoting the arm 416 allows for greater flexibility for the operator to stabilize the power tool relative to the workpiece. In other embodiments, the handle assembly 408 can further include one or more clips, couplers, links, or any other suitable extension mechanisms to increase the length of the handle assembly 408. In one example, the handle assembly 408 further includes a tool (e.g., screwdriver) insertable into the collar 412 to be used as an extension.

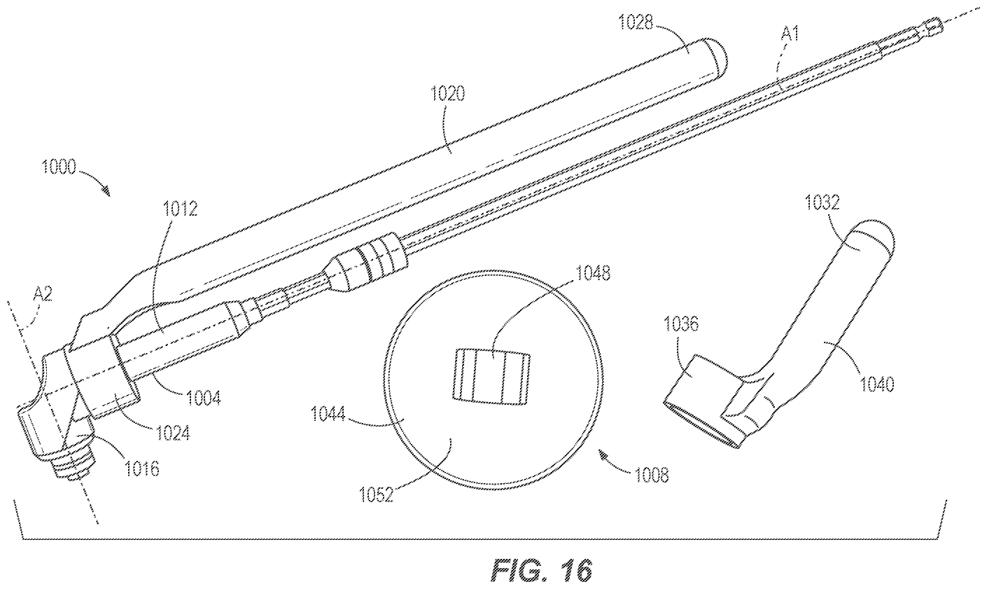

Moving ahead in the drawings, FIG. 16 illustrates an angled adapter 1000 (hereafter “the adapter 1000”) including a housing 1004 and one or more handles 1008 according to an embodiment of the invention. The adapter 1000 can include the pivoting feature (i.e., a second section of the housing pivots relative to a first section of the housing) as described above for the adapter 10. In some embodiments, the adapter 1000 may not include the pivoting feature such that the second section of the housing remains stationary or is fixed relative to the first section of the housing 1004. The adapter 1000 can be similar to the adapter 10 described above, but further includes the handles 1008. The handles 1008 are configured to be alternately coupled to the housing 1004 of the adapter 1000. The first section 1012 of the housing 1004 defines a first axis A1, and the second section 1016 of the housing 1004 defines a second axis A2 similar to the adapter 10 as illustrated in FIG. 2.

As shown in FIG. 16, the handles 1008 include a first handle 1020 having a first collar 1024 and a first arm 1028. The first collar 1024 may be removably coupled to the housing 1004 or may be permanently fixed to the housing 1004. The first arm 1028 extends from the first collar 1024. The first arm 1028 defines a first length measured from the first collar 1024 to an end of the first arm 1028 in a direction parallel to the first axis A1.

With continued reference to FIG. 16, the handles 1008 include a second handle 1032 having a second collar 1036 and a second arm 1040. The second collar 1036 may be removably coupled to the housing 1004 or may be permanently fixed to the housing 1004. The second arm 1040 extends from the second collar 1036. The second handle 1032 includes a second length measured in a direction parallel to the first axis A1. The first length is greater than the second length. In other words, the second length is less than the first length.

With continued reference to FIG. 16, the handles 1008 include a third handle 1044 having a third collar 1048 and a plate 1052. The third collar 1048 may be removably coupled to the housing 1004 or may be permanently fixed to the housing 1004. The plate 1052 extends from the third collar 1048. The illustrated plate 1052 is a generally thin, planar member. The plate 1052 can be a circular, square, or rectangular plate. The plate 1052 is shape and sized to accommodate an operator's palm. The handles 1008 provide multiple options for an operator to stabilize the power tool relative to the workpiece. The first handle 1020 and the second handle 1032 are configured to extend the reach of the tool bit for workpieces in tight spaces. The third handle 1044 allows the operator to use their palm to provide additional leverage to stabilize the power tool relative to the workpiece.

The angled adapter comprising the housing with a pivoting feature and the transmission assembly as described above can further comprise a lighting element. The lighting element can be supported by the housing. The lighting element provides improved illumination of the workpiece during power tool operation. The lighting element better illuminates the workpiece to provide for example, improved accuracy or efficiency of the power tool operation relative to the work piece.

FIG. 5 illustrates an angled adapter 420 (hereafter “the adapter 420”) including a housing 424 and a lighting element 428 according to an embodiment of the invention. The adapter 420 can include the pivoting feature (i.e., second section of the housing pivots relative to the first section of the housing) as described above for the adapter 10. In some embodiments, the adapter 420 may not include the pivoting feature such that the second section of the housing 424 remains stationary or is fixed relative to the first section of the housing 424. The adapter 420 can be similar to the adapter 10 and adapter 400 described above, but further comprises a lighting element 428.

As shown in FIG. 5, the lighting element 428 can comprise a collar 432 including one or more light emitting diodes 436 (i.e., LEDs). The collar 432 of the lighting element 428 can be coupled to the housing 424 of the adapter 420. In some embodiments, the collar 432 can be removably coupled to the housing 424. In other embodiments, the collar 432 can be permanently fixed to the housing 424. The collar 432 surrounds a portion of the housing 424 such that light emitted by the LEDs is emitted in a 360 degree pattern around the adapter 420. In other embodiments, the LEDs may be positioned on the collar 432 to emit light in less than a 360 degree pattern (e.g., in a 180 degree pattern or a 90 degree pattern).

With continued reference to FIG. 5, the lighting element 428 can be powered by a battery pack 440. The battery pack 440 can be supported by the housing 424 of the adapter 420. In other embodiments, the lighting element 428 can be powered by a power source located onboard the tool. The battery pack 440 can be connected to the lighting element 428 via one or more wires. As illustrated in FIG. 5, the battery pack 440 can comprise coin cell batteries. An actuator (e.g., a push button, a slider switch, etc.) may be located on the collar 432, the adapter 420, or the tool to selectively control (e.g., turn on and off) the lighting element 428. In some embodiments, the actuator or a separate actuator may also change modes of the lighting element 428 (e.g., high illumination, low illumination, etc.). The lighting element 428 provides 360 degrees of illumination around the adapter 420 to better illuminate the workpiece during operation of the power tool.

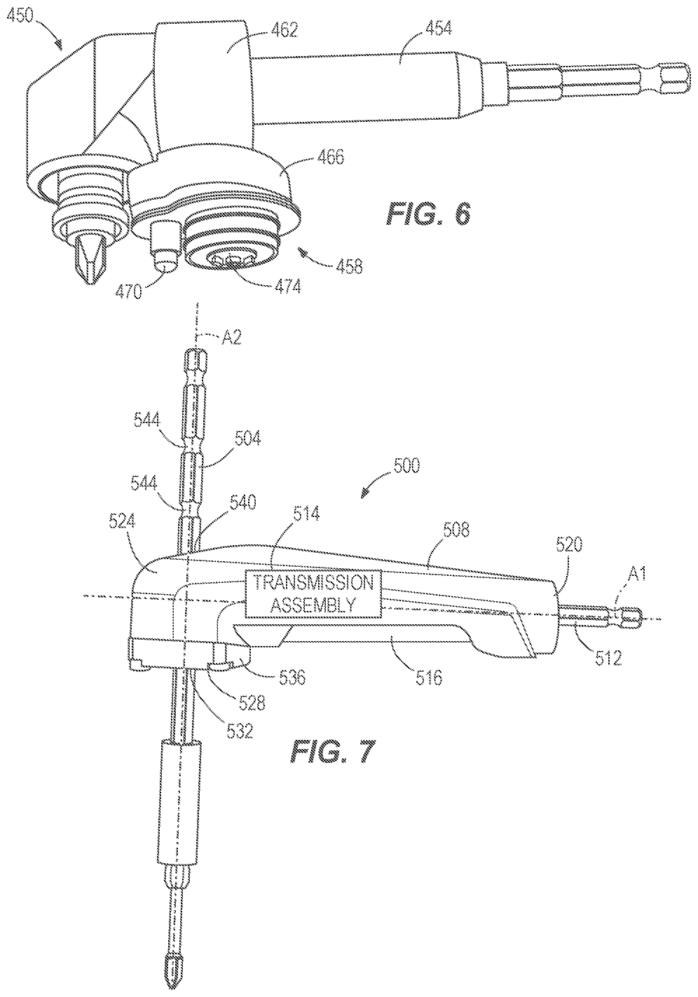

FIG. 6 illustrates an angled adapter 450 (hereafter “the adapter 450”) including a housing 454 and a lighting element 458 according to another embodiment of the invention. The adapter 450 can include the pivoting feature (i.e., second section of the housing pivots relative to the first section of the housing) as described above for adapter 10. In some embodiments, the adapter 450 may not include the pivoting feature such that the second section of the housing 454 remains stationary or is fixed relative to the first section of the housing 454. The adapter 450 can be similar to the adapter 10 and adapter 400 described above, but further comprises the lighting element 458.

As shown in FIG. 6, the lighting element 458 can comprise a collar 462, an extension element 466, and a light emitting diode 470 (i.e., LED). The extension element 466 can extend from the collar 462. The collar 462 of the lighting element 458 can be coupled to the housing 454 of the angled adapter 450. In some embodiments, the collar 462 can be removably coupled to the housing 454. In other embodiments, the collar 462 can be permanently fixed to the housing 454. The LED 470 of the lighting element 458 can be disposed on the extension element 466 to allow the LED 470 to be adjacent the tool bit location. In the illustrated embodiment, the lighting element 458 includes a single LED. In other embodiments, the lighting element 458 may include multiple LEDs. The lighting element 458 provides illumination at the tool bit location to better illuminate the tool bit connection relative to the workpiece.

With continued reference to FIG. 6, the lighting element 458 can be powered by a battery pack 474. The battery pack 474 can be positioned within or coupled to the housing 454. In other embodiments, the battery pack 474 can be a power source located on board the tool. As illustrated in FIG. 6, the battery pack 474 can comprise coin cell batteries to power the lighting element 458. An actuator (e.g., a push button, a slider switch, etc.) may be located on the collar 462, the adapter 450, or the tool to selectively control (e.g., turn on and off) the lighting element 458. In some embodiments, the actuator or a separate actuator may also change modes of the lighting element 458 (e.g., high illumination, low illumination, etc.).

In other embodiments, other lighting elements can be coupled to the housing 424 of the adapter 420 or housing 454 of the adapter 450. The lighting element can include, but not limited to, a plurality of LEDs, a light assembly, or a light assembly including a head attached to a flexible arm. The battery pack can include, but not limited to, one or more triple A batteries, one or more M4 batteries, one or more rechargeable batteries, or one or more coin cell batteries. In other embodiments still, a generator can be built into the adapters 420, 450 that uses rotational energy from the shank or tool bit to power the lighting element.

FIG. 7 illustrates an angled adapter 500 (hereafter the “adapter 500”) configured to be operatively coupled to a tool and a tool bit 504. The adapter 500 can include the pivoting feature (i.e., second section of the housing pivots relative to the first section of the housing) as described above for the adapter 10. In some embodiments, the adapter 500 may not include the pivoting feature such that the second section of the housing remains stationary or is fixed relative to the first section of the housing. The adapter 500 can be similar to the adapter 10 described above, but further includes the following differences described below.

With continued reference to FIG. 7, the adapter 500 includes a housing 508 supporting a shank 512 and a transmission assembly 514. The transmission assembly 514 of the adapter 500 can be similar to the transmission assemblies described above. The transmission assembly 514 of the adapter 500 converts the input torque about a first axis A1 to an output torque acting on the tool bit 504 to rotate the tool bit 504 about a second axis A2. The second axis A2 is disposed at an angle relative to the first axis A1 (FIG. 7).

As shown in FIG. 7, the housing 508 includes a first section 516 including a first end and a second end opposite the first end. The first end of the first section 516 defines a shank receiving aperture 520. The second end of the first section is coupled to a second section 524 of the housing 508. The first section 516 can be coupled to the second section 524 by, for example, a set of fasteners. In other embodiments, the first section 516 can be coupled to the second section 524 via a shaft similar to the shaft 50 of the adapter 10 described above. The first section 516 of the housing 508 defines a first axis A1, and the second section 524 of the housing 508 defines a second axis A2 (FIG. 7).

As illustrated in FIG. 7, the second section 524 of the housing 508 includes a tool bit adapter aperture 528. The tool bit adapter aperture 528 is disposed in facing relation to a tool bit aperture 532 defined by a third section 536 of the housing 508. The second section 524 and the third section 536 of the housing 508 can be secured together with a set of fasteners.

With continued reference to FIG. 7, the second section 524 of the housing 508 defines a passthrough aperture 540. The tool bit 504 is movable through the passthrough aperture 540 along the second axis A2. The passthrough aperture 540 allows the tool bit 504 to move or translate relative to the adapter 500. Specifically, the passthrough aperture 540 allows the tool bit to move or translate relative to the housing 508 of the adapter 500. The passthrough aperture 540 allows multiple tool bits of different lengths to be used with the adapter 500. The multiple tool bits can be used to drill different sized holes into the workpiece (e.g., short, medium, or long holes). The passthrough aperture 540 allows for example, but not limited to, a spade tool bit, a ⅜ inch tool bit, a ¼ inch hex tool bit, or hole saw tool bit to be used with the adapter 500.

With continued reference to FIG. 7, the illustrated tool bit 504 includes one or more length adjustment features 544 configured to adjust a length of the tool bit 504 relative to the third section 536 of the housing 508. The one or more length adjustment features 544 can be grooves formed in the tool bit 504. The one or more length adjustment features 544 can be equally spaced along the length of the tool bit 504. The one or more length adjustment features 544 interlock with the adapter 500 to provide a desirable tool bit length. In other embodiments, the one or more length adjustment features 544 can be links that attach to the tool bit 504 to increase or decrease the length of the tool bit 504 relative to the third section 526 of the housing 508.

In some embodiments, the passthrough aperture 540 allows multiple sections or pieces of a tool bit to be fed through the adapter 500. For example, when wanting to drill a long hole but starting in a relatively tight space, there may not be enough room to attach a long tool bit to the adapter 500. Instead, a relatively short tool bit can be initially attached to the adapter 500. During the drilling operation, additional sections of the tool bit may be fed through a rear side of the passthrough aperture 540 and attached to an end of the tool bit (e.g., via a male/female connection, a splined connection, a magnetic connection, etc.). A user may continue feeding additional sections through the rear side of the passthrough aperture 540 until a desired hole depth is achieved.

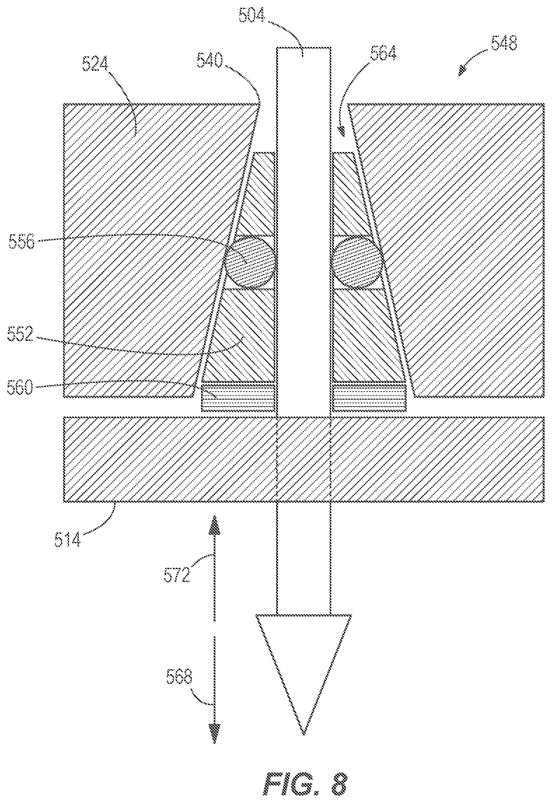

FIG. 8 illustrates a self-feeding mechanism 548 for use with the adapter 500. The self-feeding mechanism 548 allows the adapter 500 to grasp and rotate any portion of a tool bit, rather than only at a designated end of the tool bit. The illustrated self-feeding mechanism 548 includes a collet 552, one or more bearings 556, and a spring 560. The self-feeding mechanism 548 is disposed within the second section 524 of the housing 508. The second section 524 of the housing 508 defines a tapered or angled cavity 564 configured to receive the self-feeding mechanism 548. The self-feeding mechanism 548 is coupled to the transmission assembly 514. The collet 552 supports the bearings 556. The one or more bearings 556 selectively engage the tool bit 504 to inhibit axial movement of the tool bit 504, while still allowing the tool bit 504 to be rotated by the transmission assembly 514. The spring 560 is configured to provide a force that biases the collet 552 within the second section 524 of the housing 508. The biasing force of the spring 560 retains the self-feeding mechanism 548 within the second section 524 of the housing 508.

In operation, the user presses the tool bit 504 in a first direction 568 to overcome the biasing force of the spring 560 to increase the length of the tool bit 504. The bearings 556 include a radial space to allow the tool bit 504 to be moveable through the passthrough aperture 540 in the first direction 568. Once the desired tool bit length is achieved, the pressing force is removed and the spring 560 retains the self-feeding mechanism 548 within the second section 524 of the housing 508. The self-feeding mechanism 548 inhibits axial movement of the tool bit 504 in a second direction 572. The self-feeding mechanism 548 allows the adapter 500 to grasp and rotate the tool bit 504 at any desirable tool bit length. The user may continue feeding the tool bit 504 through the passthrough aperture 540 via the self-feeding mechanism 548 until a desired hole depth is achieved.

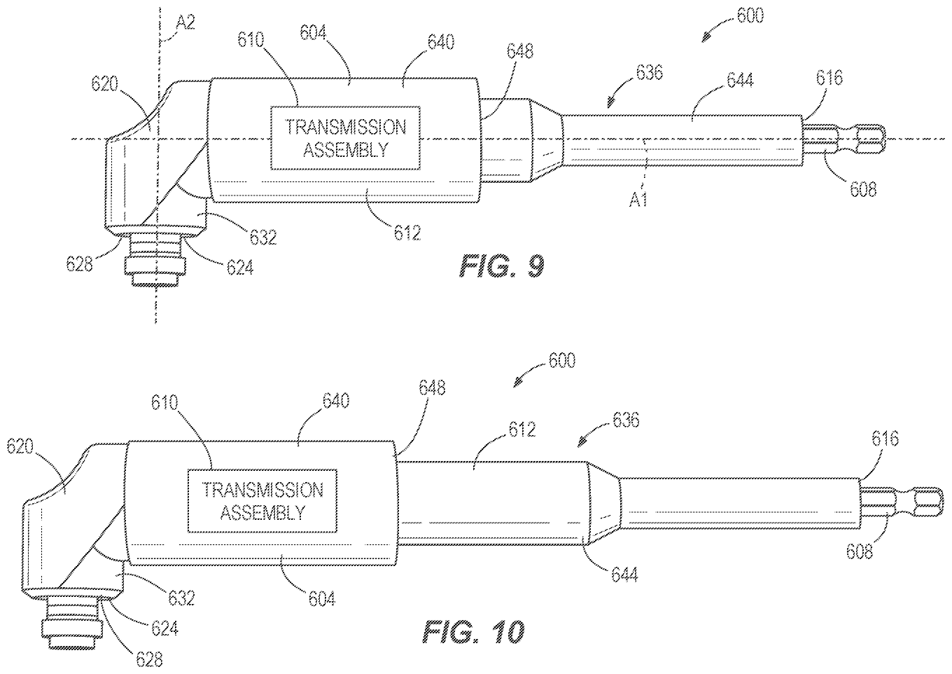

FIGS. 9 and 10 illustrate an angled adapter 600 (hereafter the “adapter 600”) configured to be operatively coupled to a tool and a tool bit. The adapter 600 can include the pivoting feature (i.e., second section of the housing pivots relative to the first section of the housing) as described above for the adapter 10. In some embodiments, the adapter 600 may not include the pivoting feature such that the second section of the housing remains stationary or is fixed relative to the first section of the housing. The adapter 600 can be similar to the adapter 10 described above, but further includes the following differences described below.

With continued reference to FIG. 9, the adapter 600 includes a housing 604 supporting a shank 608 and a transmission assembly 610. The transmission assembly 610 of the adapter 600 can be similar to the transmission assemblies described above. The housing 604 includes a first section 612 including a first end and a second end opposite the first end. The first end of the first section 612 defines a shank receiving aperture 616. The second end of the first section 612 is coupled to a second section 620 of the housing 604. The first section 612 can be coupled to the second section 620 by, for example, a set of fasteners. In other embodiments, the first section 612 can be coupled to the second section 620 via a shaft similar to the shaft 50 of adapter 10 described above. The first section 612 of the housing 604 defines a first axis A1, and the second section 620 of the housing 604 defines a second axis A2 (FIG. 9).

As shown in FIG. 9, the second section 620 of the housing 604 includes a tool bit adapter aperture 624. The tool bit adapter aperture 624 is disposed in facing relation to a tool bit aperture 628 defined by a third section 632 of the housing 604. The second section 620 and the third section 632 of the housing 604 can be secured together with a set of fasteners.

With reference to FIGS. 9 and 10, the illustrated housing 604 is an extendable or telescoping housing 604. The housing 604 includes a plurality of housing bodies 636 configured to adjust a length of the adapter 600. In particular, the first section 612 of the housing 604 includes two bodies 636 configured to extend the length of the adapter 600. In other embodiments, the housing 604 may include more than two bodies 636. The bodies 636 include a telescoping geometry to increase or decrease the length the adapter 600 along the first axis A1. In addition, the bodies 636 are shaped to transmit rotation between the bodies 636, and thereby to the transmission assembly 610 and a tool bit. In some embodiments, the bodies 636 may be surrounded by an outer shroud that covers the rotating (e.g., spinning) bodies 636. As illustrated in FIGS. 9 and 10, the first section 612 of the housing 604 includes a first body 640 and a second body 644. The first body 640 defines a receiving bore or aperture 648 configured to receive the second body 644. The second body 644 moves relative to the adapter 600 to increase or decrease the length of the adapter 600. The second body 644 moves relative to the first body 640 to adjust the length of the adapter 600.

In operation, the adapter 600 is in a contracted state as shown in FIG. 9. In the contracted state, the second body 644 of the adapter 600 is disposed within the first body aperture 648. To increase the length of the adapter 600, the operator moves the second body 644 relative to the first body 640 to extend the length of the adapter 600. As shown in FIG. 10, the adapter 600 is in an extended state, where the second body 644 is extended or positioned away from the first body 640. In some embodiments, the bodies 640, 644 can include a detent, catch, or other mechanism (e.g., magnets, etc.) to releasably secure the adapter 600 in the contracted state and/or the extended state. Additionally, in some embodiments, the bodies 640, 644 may be releasably secured in other intermediate positions between the contracted and extended states. In other embodiments, the adapter 600 can include the first body 640, the second body 644, and a third body (not shown). In other embodiments still, the adapter 600 can include the first body 640, the second body 644, a third body (not shown), and a fourth body (not shown). The one or more bodies 636 of the adapter 600 provide an operator flexibility to increase or decrease the length of the adapter 600 to improve the stability of the tool during the power tool operation.

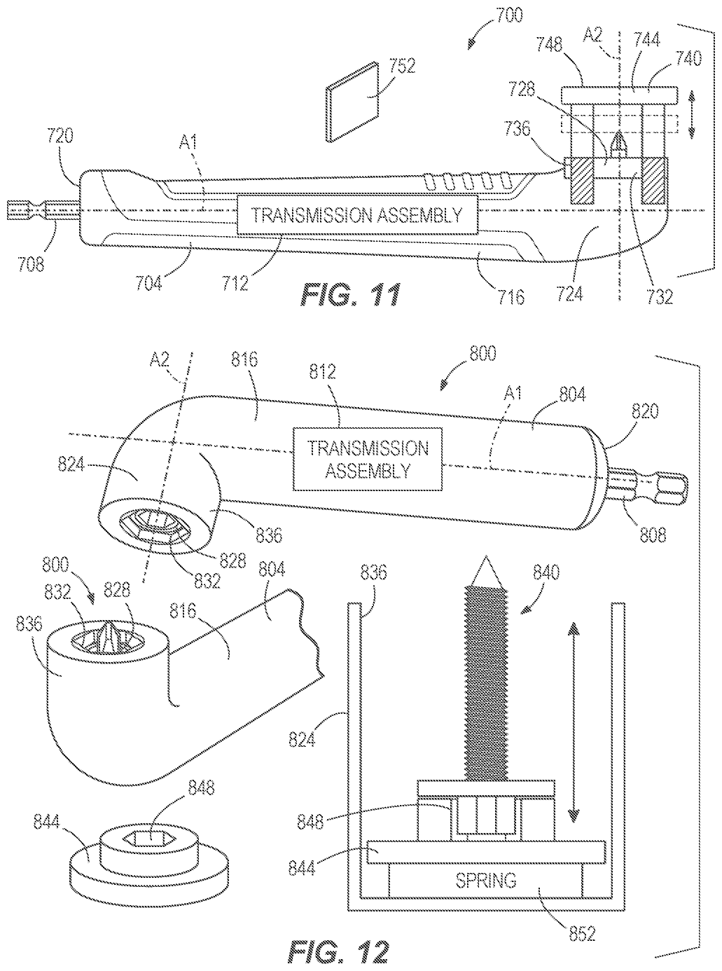

FIG. 11 illustrates an angled adapter 700 (hereafter the “adapter 700”) configured to be operatively coupled to a tool and a tool bit. The adapter 700 can include the pivoting feature (i.e., second section of the housing pivots relative to the first section of the housing) as described above for the adapter 10. In some embodiments, the adapter 700 may not include the pivoting feature such that the second section of the housing remains stationary or is fixed relative to the first section of the housing. The adapter 700 can be similar to the adapter 10 described above, but further includes the following differences described below.

With continued reference to FIG. 11, the adapter 700 includes a housing 704 supporting a shank 708 and a transmission assembly 712. The transmission assembly 712 of the adapter 700 can be similar to the transmission assemblies described above. The housing 704 includes a first section 716 having a first end and a second end opposite the first end. The first end of the first section 716 defines a shank receiving aperture 720. The second end of the first section 716 is coupled to a second section 724 of the housing 704. The first section 716 can be coupled to the second section 724 by, for example, a set of fasteners. In other embodiments, the first section 716 can be coupled to the second section 724 via a shaft similar to shaft 50 described above. The first section 716 of the housing 704 defines a first axis A1, and the second section 724 of the housing 704 defines a second axis A2 (FIG. 11).

As shown in FIG. 11, the second section 724 of the housing 704 includes a tool bit adapter aperture 728. The tool bit adapter aperture 728 is disposed in facing relation to a tool bit aperture 732 defined by a third section 736 of the housing 704. The second section 724 and the third section 736 of the housing 704 can be secured together with a set of fasteners.

With continued reference to FIG. 11, the adapter 700 includes a grip collar 740 configured to hold the adapter 700 to the workpiece. The grip collar 740 is coupled to the third section 736 of the housing 704. The grip collar 740 defines a grip collar aperture 744 configured to receive the tool bit. The grip collar aperture 744 allows the tool bit to move (e.g., linearly slide) relative the grip collar 740. The grip collar 740 may include a magnetic plate or magnet 748. The grip collar 740 can further include a grip plate 752. The adapter 700 grips the workpiece via the grip collar 740. The grip collar 740 is configured to hold the adapter 700 to the workpiece during, for example, adjustments to the length of the adapter 700 to provide better leverage relative to the workpiece. The grip collar 740 improves the alignment of the adapter 700 relative the workpiece to provide improved stability or leverage during the power tool operation.

FIG. 12 illustrates an angled adapter 800 (hereafter the “adapter 800”) configured to be operatively coupled to a tool and a tool bit. The adapter 800 can include the pivoting feature (i.e., second section of the housing pivots relative to the first section of the housing) as described above for the adapter 10. In some embodiments, the adapter 800 may not include the pivoting feature such that the second section of the housing remains stationary or is fixed relative to the first section of the housing. The adapter 800 can be similar to the adapter 10 described above, but further includes the following differences described below.

With continued reference to FIG. 12, the adapter 800 includes a housing 804 supporting a shank 808 and a transmission assembly 812. The transmission assembly 812 can be similar to the transmission assemblies described above. The housing 804 includes a first section 816 including a first end and a second end opposite the first end. The first end defines a shank receiving aperture 820. The second end of the first section 816 is coupled to a second section 824 of the housing 804. The first section 816 can be coupled to the second section 824 by, for example, a set of fasteners. In other embodiments, the first section 816 can be coupled to the second section 824 via a shaft similar to the shaft 50 of adapter 10 described above. The first section 816 of the housing 804 defines a first axis A1, and the second section 824 of the housing 804 defines a second axis A2 (FIG. 12).

As shown in FIG. 12, the second section 824 of the housing 804 includes a tool bit adapter aperture 828. The tool bit adapter aperture 828 is disposed in facing relation to a tool bit aperture 832 defined by a third section 836 of the housing 804. The second section 824 and the third section 836 of the housing 804 can be secured together with a set of fasteners.

With continued reference to FIG. 12, the adapter 800 includes a capture mechanism 840. The capture mechanism 840 can be disposed in the second section 824 and/or the third section 836 of the housing 804. The capture mechanism 840 includes a base 844 defining a base aperture 848, and a spring 852. A screw (e.g., a D- or hex-shaped head) is configured to be received within the base aperture 848 (e.g., a corresponding D- or hex-shaped aperture). The screw is rotationally locked relative to the base 844. The base 844 is also configured to be linearly slidable relative to the second section 824 and/or the third section 836 of the housing 804. The base 844 may be coupled to, for example, a bevel gear of the transmission assembly 812 to transmit drive force from the transmission assembly 812 to the screw through the base 844. The base 844 is in contact with the spring 852 such that the spring 852 provides a biasing force against the base 844. The spring 852 allows the base 844 to linearly slide relative to the second section 824 and/or the third section 836 of the housing 804.

In operation, a user inserts a screw into the base aperture 848 of the base 844. The screw may push the base 844 into the second section 824 and/or the third section 836 of the housing 804 such that a majority of the screw is received in the housing. For example, the screw may push the base 844 against the spring 852 when the screw engages a workpiece. Alternatively, if the screw is already installed in the workpiece, the adapter 800 may be brought into engagement with the screw to push the base 844 against the spring 852. The base 844 is then rotated by the transmission assembly 812 to drive the screw into the workpiece or unthread the screw from the workpiece. As the screw is driven into or retracted from the workpiece, the base 844 linearly slides, or floats, within the housing 804 to move with the screw. The capture mechanism 840 allows for a low screw height relative to the second section 824 and/or third section 836 of the housing 804 to limit the loss of screws during the power tool operation. Further, with the low screw height, the user's hand can be positioned closer to the pivot point of the screw thereby allowing for more control of the adapter 800 during the power tool operation.

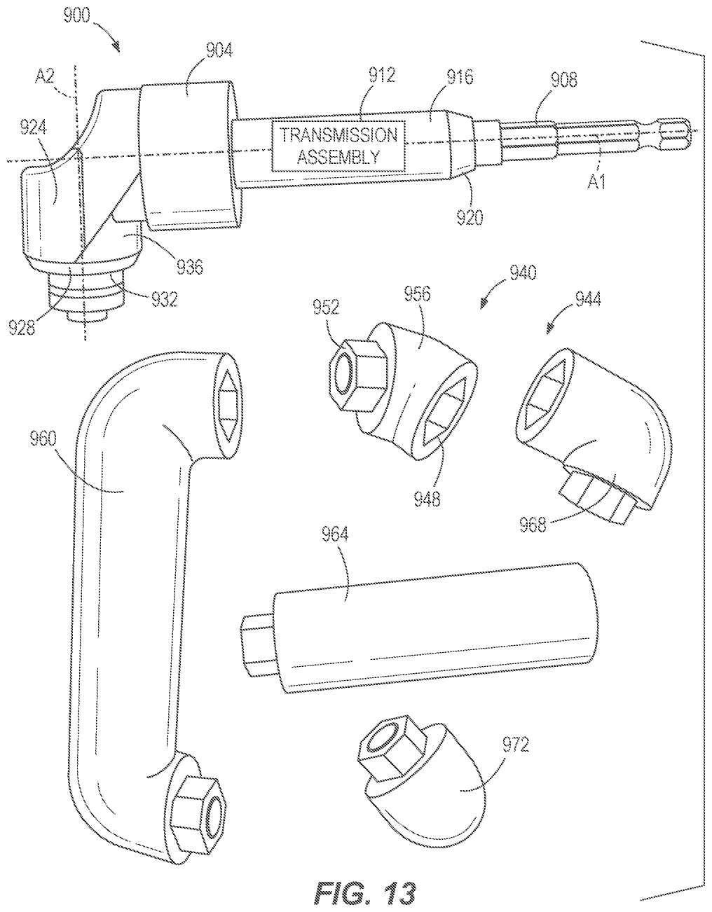

FIG. 13 illustrates an angled adapter 900 (hereafter the “adapter 900”) configured to be operatively coupled to a tool and a tool bit according to another embodiment. The angled adapter 900 can include the pivoting feature (i.e., second section of the housing pivots relative to the first section of the housing) as described above for the adapter 10. In some embodiments, the adapter 900 may not include the pivoting feature such that the second section of the housing remains stationary or is fixed relative to the first section of the housing. The adapter 900 can be similar to the adapter 10 described above, but further include following differences described below.

With continued reference to FIG. 13, the adapter 900 includes a housing 904 supporting a shank 908 and a transmission assembly 912. The transmission assembly 912 can be similar to the transmission assemblies described above. The housing 904 includes a first section 916 including a first end and a second end opposite the first end. The first end of the first section 916 defines a shank receiving aperture 920. The second end of the first section 916 is coupled to a second section 924 of the housing 904. The first section 916 can be coupled to the second section 924 by, for example, a set of fasteners. In other embodiments, the first section 916 can be coupled to the second section 924 via a shaft similar to the shaft 50 of the adapter 10 described above. The first section 916 of the housing defines a first axis A1, and the second section 924 of the housing 904 defines a second axis A2 (FIG. 13).

As shown in FIG. 13, the second section 924 of the housing 904 includes a tool bit adapter aperture 928. The tool bit adapter aperture 928 is disposed in facing relation to a tool bit aperture 932 defined by a third section 936 of the housing 904. The second section 924 and the third section 936 of the housing 904 can be secured together with a set of fasteners.

FIG. 13 illustrates an external shell or shell 940 configured to be operatively coupled to the adapter 900 and the tool bit. The shell 940 is coupled to the housing 904 of the adapter 900. Specifically, the shell 940 is coupled to the third section 936 of the housing 904. The shell 940 includes a geometry (e.g., complementary hex protrusion and hex aperture) configured to be coupled to a receiving geometry of the third section 936. In one embodiment, the geometry of the shell 940 locks with the complementary geometry of the third section 936 such that the shell 940 rotates and clicks to various positions relative to the adapter 900. In one example, the shell 940 includes eight locking positions to adjust the position of the shell 940 relative to the adapter 900.

The shell 940 includes one or more shell bodies 944 (e.g., links, tubes, pieces, joints) configured to be coupled together. The one or more shell bodies 944 interlock together via protrusions and complementary apertures. In one example, the one or more shell bodies 944 include a hex aperture 948 configured to receive a hex protrusion 952. The one or more shell bodies 944 include a shape. The shape of the one or more shell bodies 944 can include, but not limited to, a u shape, an elongated shape, a 90 degree shape, a single bend, or a double bend.

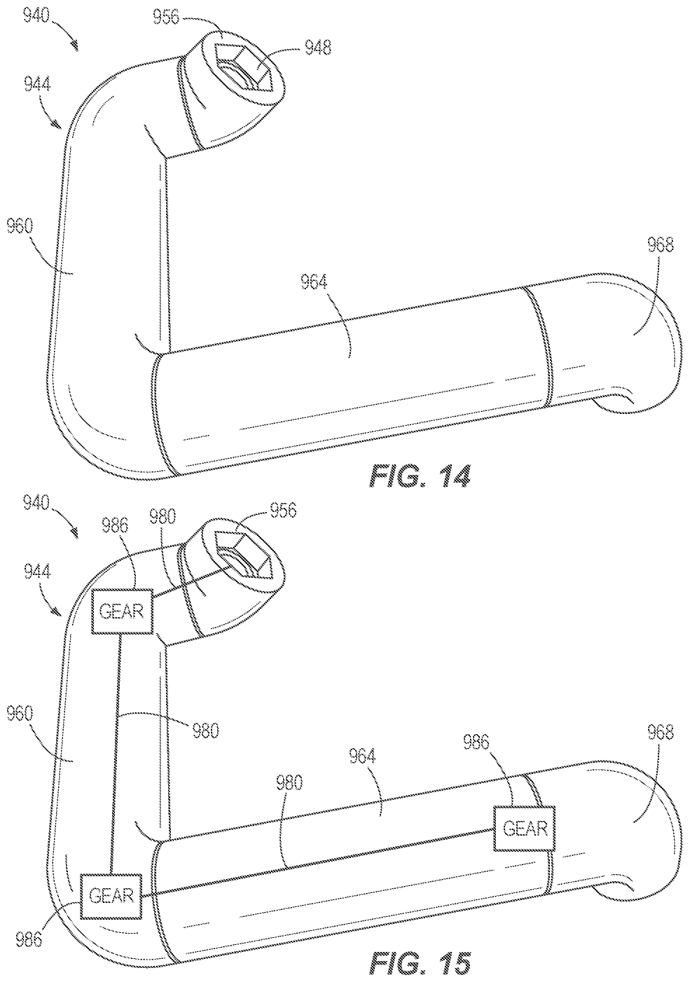

As illustrated in FIG. 13, the shell 940 includes a first shell body 956, a second shell body 960, a third shell body 964, a fourth shell body 968, and a fifth shell body 972. The first shell body 956, the second shell body 960, the third shell body 964, the fourth shell body 968, and the fifth shell body 972 may be coupled together to from the shell 940 (FIG. 14). The first shell body 956, the second shell body 960, the third shell body 964, the fourth shell body 968, and the fifth shell body 972 can interlock with one another to form the shell 940. In some embodiments, only a subset of the shell bodies 956, 960, 964, 968, 972 may be used to form the shell 940. In other embodiments, the shell 940 may include two or more of any or all of the shell bodies 956, 960, 964, 968, 972. In still other embodiments, the shell 940 ma include other shell bodies having other shapes and/or sizes. The shell 940 provides an operator multiple options to better position the power tool relative to the workpiece in tight spaces.

FIG. 15 illustrates the shell 940 further including a drive train 976. The drive train 976 includes one or more internal shafts 980 and one or more bevel gears 986. The drive train 976 is configured to transmit power from the adapter 900 to the tool bit via the shell 940. The drive train 976 including the one or more internal shafts 980 and one or more bevel gears 986 are disposed within the one or more shell bodies 944. The shell 940 allows an operator to create a unique shape between the adapter 900 and the tool bit to accommodate workpieces in tight spaces. The shell 940 including the one or more shell bodies 944 provides a plurality of angles between the power tool and the workpiece to accommodate workpieces in tight spaces.

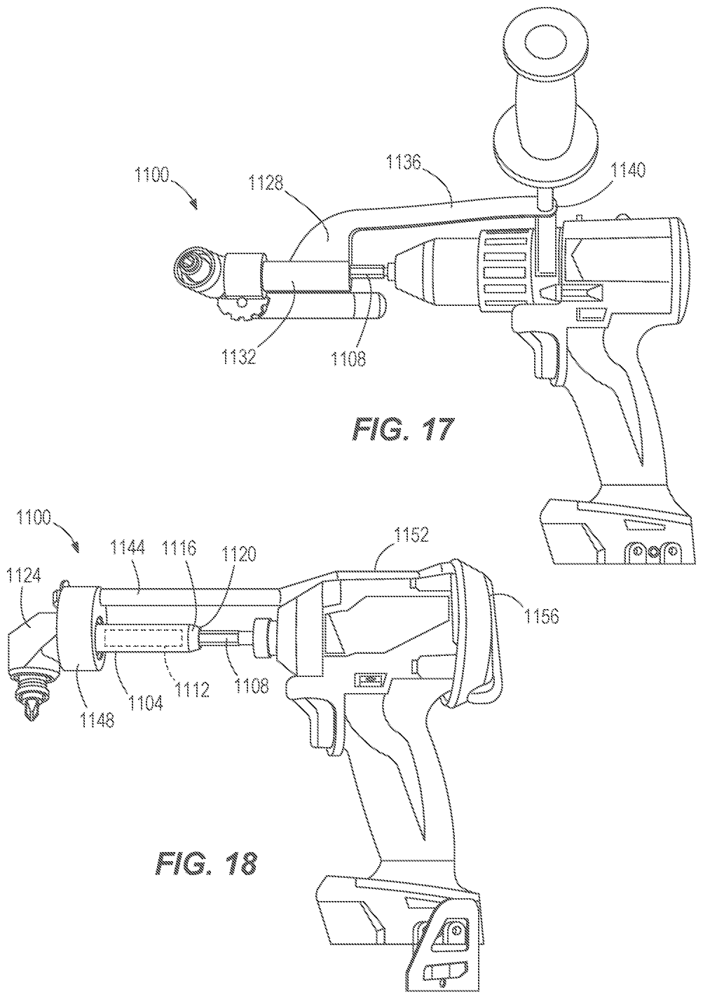

FIGS. 17 and 18 illustrate an angled adapter 1100 (hereafter the “adapter 1100”) configured to be operatively coupled to a tool and a tool bit according to another embodiment of the invention. The adapter 1100 can include the pivoting feature (i.e., second section of the housing pivots relative to the first section of the housing) as described above for the adapter 10. In some embodiments, the adapter 1100 may not include the pivoting feature such that the second section of the housing remains stationary or is fixed relative to the first section of the housing. The adapter 1100 can be similar to the adapter 10 described above, but further includes following differences described below.

With continued reference to FIGS. 17 and 18, the adapter 1100 includes a housing 1104 supporting a shank 1108 and a transmission assembly 1112. The transmission assembly 1112 can be similar to the transmission assemblies described above. The housing 1104 includes a first section 1116 including a first end and a second end opposite the first end. The first end defines a shank receiving aperture 1120. The second end of the first section 1116 is coupled to a second section 1124 of the housing 1104. The first section 1116 can be coupled to the second section 1124 by, for example, a set of fasteners. In other embodiments, the first section 1116 can be coupled to the second section 1124 via a shaft similar to the shaft 50 of adapter 10 described above. The first section 1116 of the housing 1104 defines a first axis A1, and the second section 1124 of the housing 1104 defines a second axis A2 similar to the adapter 10 as shown in FIG. 2.

FIG. 17 illustrates a first tool mount or first mount 1128 configured to be coupled to the adapter 1100 and the tool according to an embodiment of the invention. The first mount 1128 includes a first mount collar 1132, a first mount link 1136, and a first mount clamp 1140. The first mount collar 1132 of the first mount 1128 is configured to be coupled to the housing 1104 of the adapter 1100. The first mount collar 1132 can be removably coupled to the housing 1104 or can be permanently fixed to the housing 1104. The first mount link 1136 extends from the first mount collar 1132 to the tool. The first mount collar 1132 is coupled to an end of the first mount link 1136. The first mount clamp 1140 is configured to grip a portion of the tool when the first mount 1128 is installed onto the tool. In the illustrated embodiment, the first mount clamp 1140 engages a side handle of the tool. In other embodiments, the first mount clamp 1140 can grip a top portion of the tool (e.g., neck or gear case of the tool). The first mount 1128 inhibits rotational movement and side to side movement (i.e., flopping) of the adapter 1100 during the power tool operation. In some embodiments, the first mount 1128 can be attached or clipped into an extendable handle or telescoping handle as described above. The first mount 1128 allows the driving or drilling to be executed at the tool rather than separately away from the tool. The first mount 1128 allows for an additional point of leverage to stabilize the tool relative to the workpiece.

FIG. 18 illustrates a second tool mount or second mount 1144 for the adapter 1100 according to another embodiment of the invention. The second mount 1144 can be a clamp style mount. The second mount 1144 includes a second mount collar 1148, a second mount link 1152, and a second mount clamp 1156. The second mount collar 1148 can be removably coupled to the housing 1104 or can be permanently fixed to the housing 1104. The second mount collar 1148 can include a locking mechanism (e.g., quick locking rotating head) that locks the second mount collar 1148 to the housing 1104. The second mount link 1152 extends from the second mount collar 1148 to the tool. The second mount clamp 1156 is coupled to an end of the second mount link 1152. The second mount clamp 1156 is configured to grip a portion of the tool when the second mount 1144 is installed onto the tool. In the illustrated embodiment, the second mount clamp 1156 can grip a rearward end of the tool, opposite from an output of the tool. The second mount clamp 1156 provides a clamping force to clamp the second mount 114 to the tool. The second mount clamp 1156 includes a geometry that interlocks with the tool to inhibit movement of the adapter 1100 during the power tool operation. The second mount 1144 inhibits rotational movement and side to side movement (i.e., flopping) of the adapter 1100 during the power tool operation. In some embodiments, the second mount 1144 can be attached or clipped into an extendable handle or telescoping handle as described above. The second mount 1144 allows the driving or drilling to be executed at the tool rather than separately away from the tool. The second mount 1144 allows for an additional point of leverage to stabilize the tool relative to the workpiece.

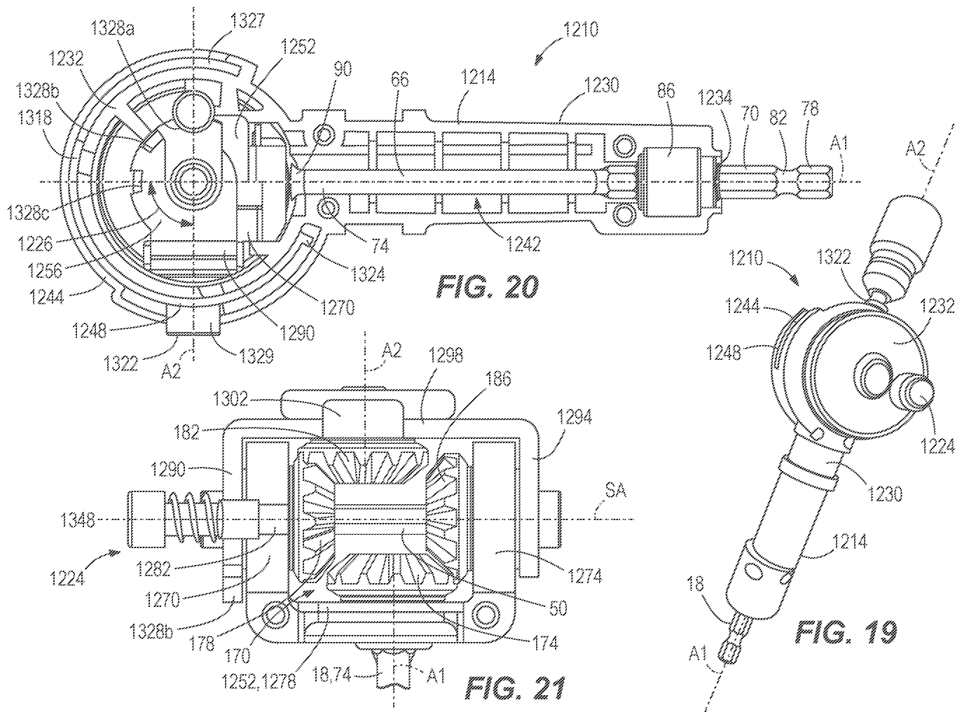

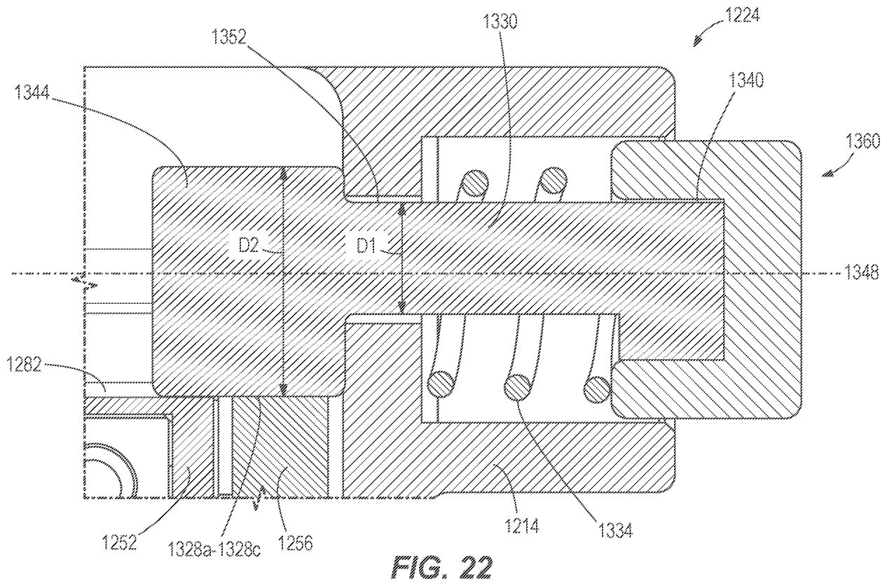

FIGS. 19-22 illustrate an angled adapter 1210 (hereafter “the adapter 1210”) configured to operatively couple to a tool (e.g., a power tool, such as a drill/driver) and a tool bit (not shown). The adapter 1210 includes a housing 1214 supporting a shank 18, a transmission assembly 170, and a lock assembly 1224. As discussed above, the shank 18 is driven to rotate about a first axis A1 by a torque applied by the tool. The shank 18 is operatively coupled to the transmission assembly 170. The transmission assembly 170 converts the input torque about the first axis A1 to an output torque acting on the tool bit to drive the tool bit to rotate about a second axis A2 that is disposed at an angle 1226 relative to the first axis A1. The shank 18 of FIGS. 19-22 has the same features as the shank 18 of FIG. 1. Also, the transmission assembly 170 has the same features as the transmission assembly of FIG. 3B. The features of the shank 18 and the transmission assembly 170 of FIGS. 19-22 have the same reference numerals as those shown in FIGS. 1 and 3B.

With continued reference to FIG. 19, the housing 1214 includes a first section 1230 that is configured to support the shank 18 and a second section 1232 that is configured to support the transmission assembly 170.

The first section 1230 includes a shank receiving aperture 1234 at a first end. The first section 1230 of the housing 1214 defines a cavity 1242 between the first end and the second end. A generally arcuate slot 1244 is defined in the second section 1232. In the illustrated embodiment, the housing 1214 is a clamshell housing with a first clamshell half and a second clamshell half. A shield 1248 is movably coupled to the second section 1232 to close the slot 1244, as will be discussed in greater detail below.

The second section 1232 supports a first support member 1252 and a second support member 1256. The first support member 1252 is fixedly coupled to the housing 1214 (e.g., the second housing section 1232). The second support member 1256 is movably coupled relative to the first support member 1252. The first support member 1252 and the second support member 1256 can be coupled together via a shaft 50 extending along a shaft axis SA (FIG. 21). The first section 30 of the housing 14 defines the first axis A1, and the second support member 1256 defines the second axis A2.

The first support member 1252 includes a first leg 1270 and a second leg 1274 that extend from a base 1278. The base 1278 supports the transmission coupling portion 74 (and the second input bearing 94, when present) of the shank 18 and the first bevel gear 174 of the transmission assembly 170. The first leg 1270 supports the second bevel gear 178 and the second leg 1274 supports the fourth bevel gear 186. The shaft 50 extends between the first leg 1270 and the second leg 1274 of the first support member 1252. The first leg 1270 includes an opening 1282 that is configured to receive a portion of the lock assembly 1224.

The second support member 1256 includes a first leg 1290 and a second leg 1294 that form a base 1298. The base 1298 supports a tool bit adapter 1302, which has an aperture 1306 for receiving and securing a tool bit, and the third bevel gear 182 of the transmission assembly 170. The third bevel gear 182 is therefore movable (e.g., pivotable) with the second support member 1256 relative to the first support member 1252. The first leg 1290 of the second support member 1256 overlaps the first leg 1270 of the first support member 1252 and the second leg 1294 of the second support member 1256 overlaps the second leg 1274 of the first support member 1252. The shaft 50 extends between the first leg 1290 and the second leg 1294 of the second support member 1256.

With continued reference to FIGS. 19 and 20, the tool bit adapter aperture 1306 is disposed along the axis A2 and is therefore disposed at an angle relative to the shank receiving aperture 1234. In other words, a plane defined by the first transmission aperture 1238 and extending along the first axis A1 can be angled (e.g., acute, perpendicular, obtuse) to a plane defined by the tool bit adapter aperture 1306 and extending along the second axis A2. The tool bit adapter 1302 is configured to be accessible through the slot 1244.

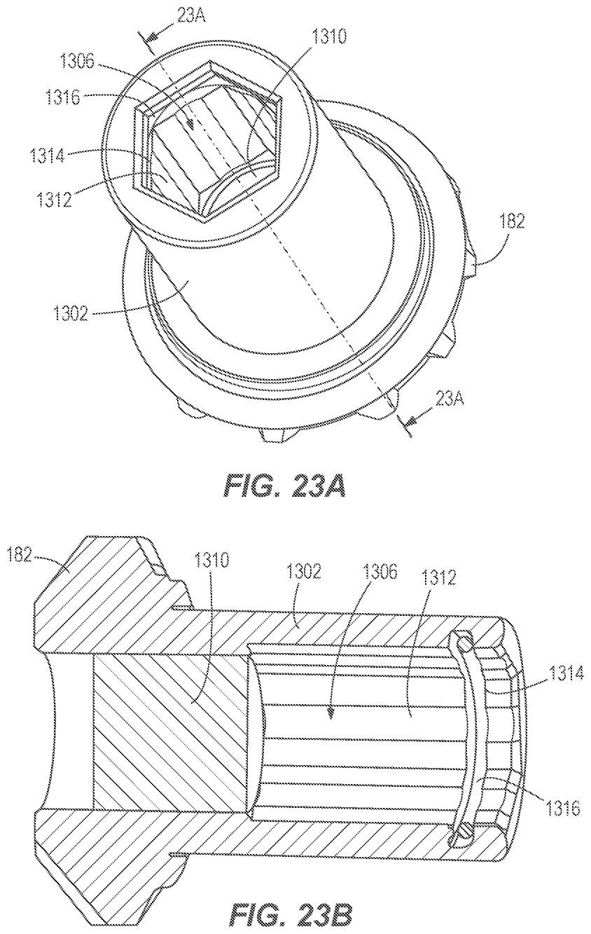

In the illustrated embodiment, the third bevel gear 182 and the tool bit adapter 1302 may be a single unitary piece. In such case, as shown in FIGS. 23A and 23B, the aperture 1306 supports a magnet 1310. Also, a wall 1312 defining the aperture 1306 may have a circumference groove 1314 having a retaining ring 1316 (e.g., O-ring). The magnet 1310 is configured to magnetically couple to a tool bit (not shown), while the retaining ring 1316 is configured to hold a fastener (e.g., a screw) to the tool bit. In other embodiments, the tool bit adapter 1302 may be a separate piece from the third bevel gear 178.

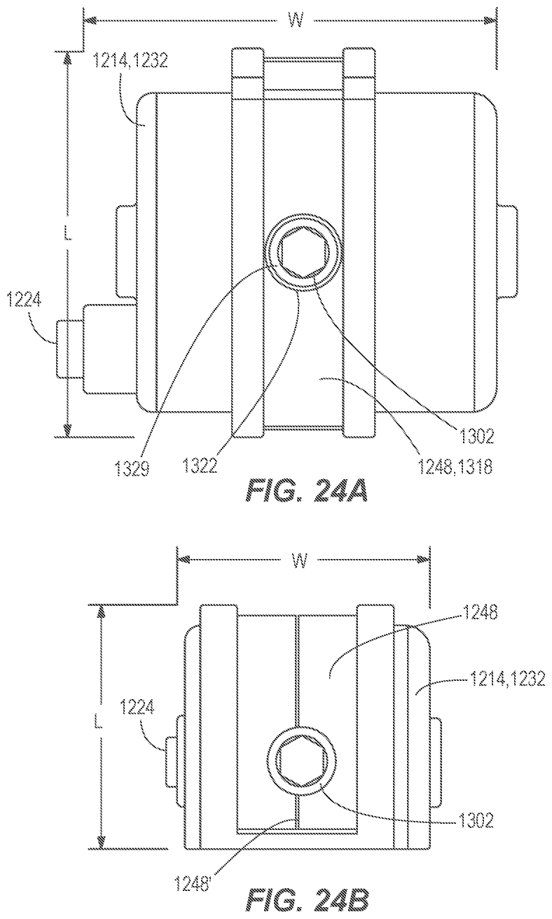

Also, in the illustrated embodiment, the tool bit adapter 1302 is coupled to and movable with the shield 1248. In the illustrated embodiment, the shield 1248 includes a body 1318, a projection 1320 extending from the body 1318, and a hook 1326 located at one end of the body 1318. The body 1318 is at least partially positioned within the second section 1232 of the housing (e.g., between the clamshell halves of the housing 1214). In the illustrated embodiment, edges of the body 1318 may be received in complementary grooves 1327 (only one of which is shown) the housing 1214. The grooves 1327 guide the shield along a generally arcuate path. The tool bit adapter 1302 may be supported in part by an aperture 1329 (FIG. 24A) that extends through the projection 1322 of the shield 1248. Accordingly, movement of the second support member 1256 results in movement of the tool bit adapter 1302 and the shield 1248, which occur simultaneously. As shown, the body 1318 is longer than the slot 1244, such that the body 1318 covers the slot 1244 to protect the transmission assembly 170. In the illustrated embodiment, the shield is constructed from plastic or any other suitable material.

In other embodiments, the shield 1248 have other configurations. For example, in some embodiments such as that shown in FIG. 24B, the shield 1248 may be flexible piece of material (such as, for example without limitation, neoprene, latex, or rubber) coupled to the housing 1214. The shield 1248 may include a slit 1248′ through which the tool bit adapter extends. In such case, the shield 1248 is configured to allow the tool bit adapter 1302 to move along slot 1244 and the slit 1248′. The shield 1248 is configured to seal around the tool bit adapter 1302.

In the illustrated embodiment, the first leg 1290 of the second support member 1256 defines a ratchet. That is, the first leg 1290 includes a plurality of recesses 1328a-1328c. Each of the recesses 1328a-1328c is configured to align with the opening 1282 in the first leg 1270 of the first support member 1252. A portion (e.g., a pawl) of the lock assembly 1224 is configured to be selectively positioned within each recess 1328a-1328c to lock the second support member 2281256 relative to the first support member 1252.

The lock assembly 1224 of FIGS. 19-22 includes a lock 1330 and a biasing mechanism 1334 (e.g., a spring). The lock 1330 includes a body having a first end 1340 and a second end 1344 opposite the first end 1340. The first end 1340 is accessible to the user from outside of the housing 1214. The second end 1344 is positioned within the housing 1214 and defines a pawl. The lock 1330 is positioned along an axis 1348 that is angled (e.g., perpendicular) to the first axis A1 and parallel relative to the shaft axis SA. The body includes a portion 1352 between the first end 1340 and the second end 1344 that has a first dimension D1 that is smaller than a second dimension D2 of the second end 1344. The biasing mechanism 1334 is positioned between the housing 1214 and the first end 1340 of the lock 1330.

The lock 1330 is movable between a first position and a second position. In the first position, the second end 1344 is biased by the biasing mechanism 1334 against the housing 1214 and seated within the opening 1282 of the first leg 1270 of the first support member 1252 and one of the recesses 1328a-1328c of the first leg 1290 of the second support member 1256. In the first position, the second support member 1256 cannot move relative to the first member 1252. In the second position, the second end 1344 is spaced apart from the housing 1214 such that the second end 1344 is positioned further into the opening 1282 of the first leg 1270 of the first support member 1252. Accordingly, the second end 1344 is not positioned within the corresponding recess 1328a-1328c of the first leg 1290 of the second support member 1256. In the second position, the second support member 1256 can move relative to the first support member 1252 because the smaller portion 1352 is spaced apart from the first leg 1290. A force in the direction of arrow 1360 (which angled, e.g., perpendicular, to the axis A1) overcomes the bias of the biasing mechanism 1334 to move the lock 1330 from the first position to the second position. When the force is released, the biasing mechanism 1334 automatically moves the lock 1330 from the second position to the first position.

In the illustrated embodiment, there are three recesses 1328a, 1328b, 1328c, so the second support member 1256 can move relative to the first support member 1252 and be locked in three different positions. When the second end 1344 of the lock 1330 is positioned within the first recess 1328a, the second support member 1256 (and therefore the tool bit adapter 1302) is oriented at a first angle (e.g., a 90-degree angle). When the second end 1344 of the lock 1330 is positioned within the second recess 1328b, the second support member 1256 (and therefore the tool bit adapter 1302) is oriented at a second angle (e.g., a 45-degree angle). When the second end 1344 of the lock 1330 is positioned within the third recess 1328c, the second support member 1256 (and therefore the tool bit adapter 1302) is oriented at a third angle (e.g., a 180-degree angle). In other embodiments, there may be more or fewer recesses 1328 and therefore the second support member 1256 could be locked in more or fewer positions. Additionally, the recesses 1328a-1328c may be configured such that the first angle, second angle, or third angle may be any suitable angle ranging from 75 degrees to 180 degrees.

With respect to FIG. 21, the third bevel gear 182 is movable (e.g., pivotable) with the second support member 1256 as the second support member 1256 pivots among the angles 1226. Accordingly, the teeth 198 of the third bevel gear 182 engage the teeth 194 of the second bevel gear 178 at each of the angles 1226.

As shown in FIGS. 24A and 24B, the housing 1214, and in particular the second housing section 1232, can be sized and shaped to accommodate a variety of applications. For example, the second housing section 1232 can have a length L that ranges from 40 mm to 60 m and a width that ranges from 40 mm to 70 mm.

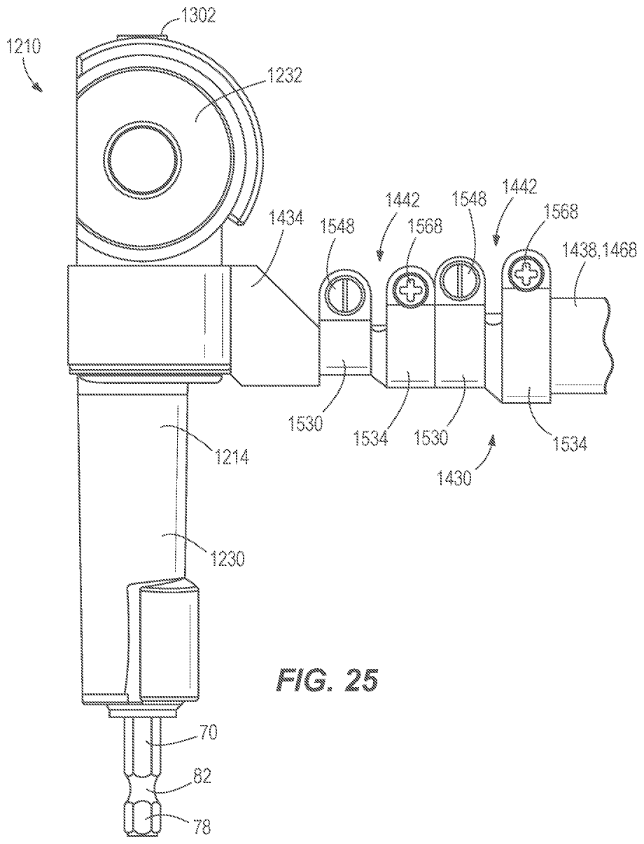

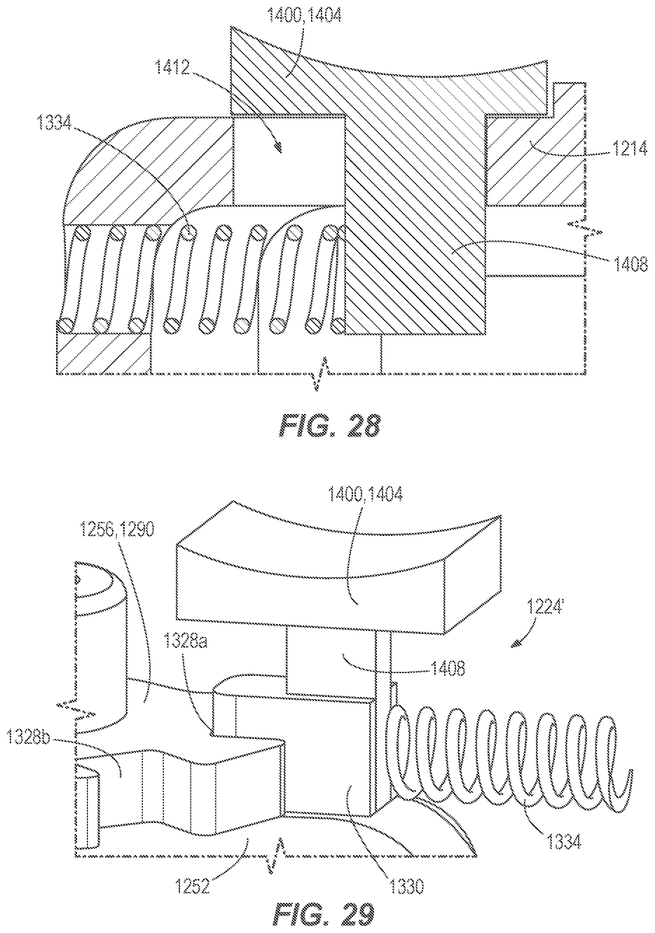

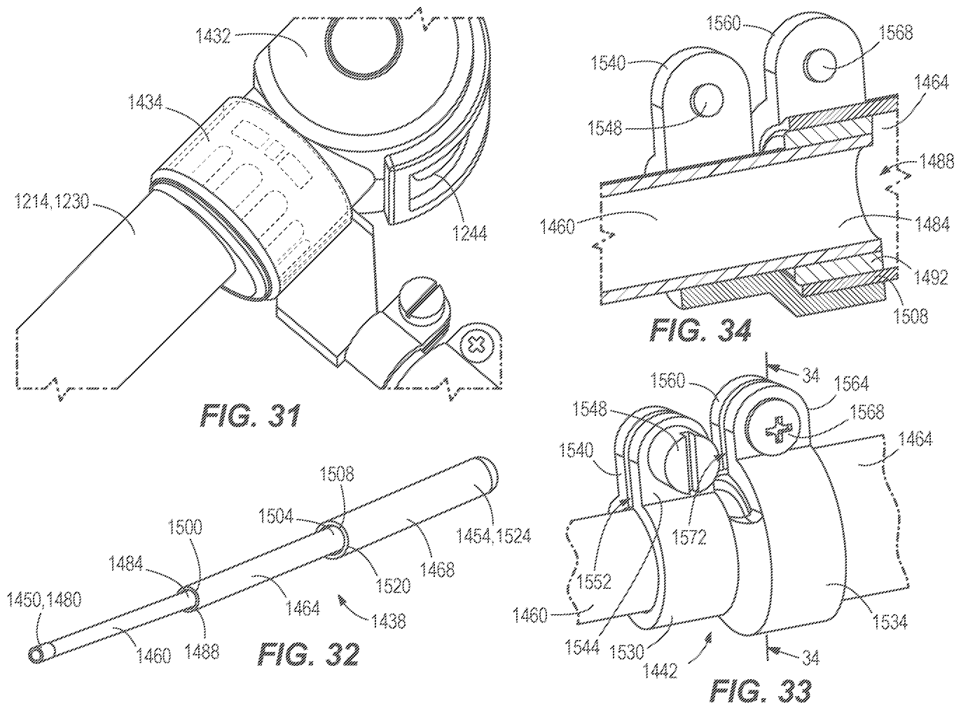

FIGS. 25-29 and 31-34 illustrate an angled adapter 1210 that is similar to the angled adapter 1210 of FIGS. 19-22. Like reference numerals will be used for like structure and only the differences discussed.

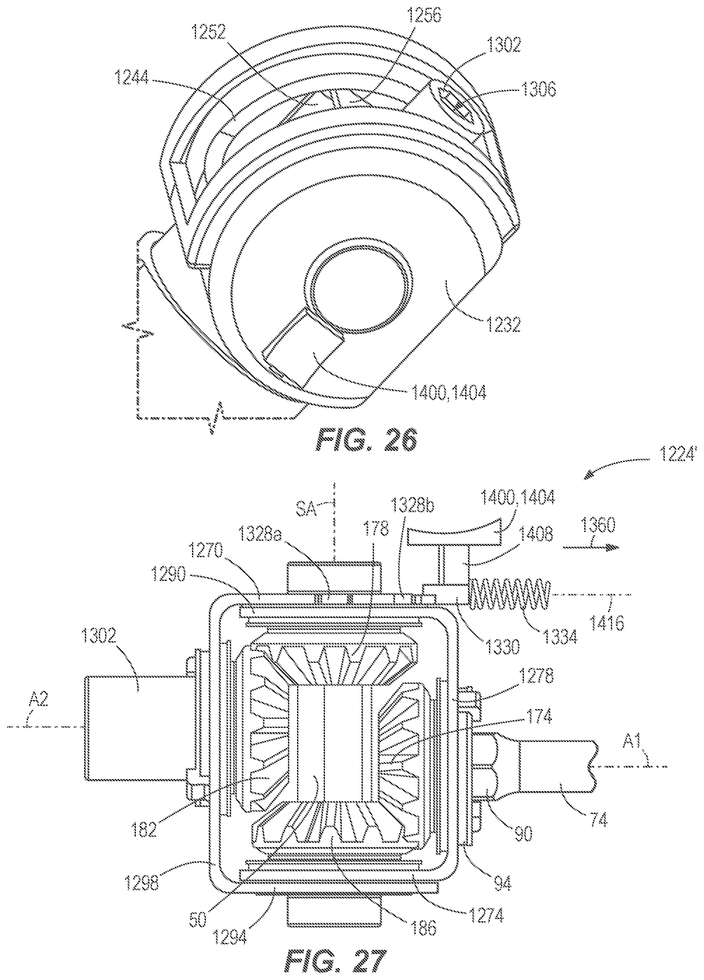

The adapter 1210 of FIGS. 25-29 and 31-34 includes a different lock assembly 1224′ than the lock assembly 1224 of FIGS. 19-22. As shown in FIGS. 26-29, the lock assembly 1224′ includes a lock 1330 (e.g., a pawl), an actuator 1400 coupled to the lock 1330, and a biasing mechanism 1334 (e.g., a spring) configured to engage the lock 1330. In the illustrated embodiment, the lock 1330 is coupled to the actuator 1400. In some embodiments, the lock 1330 may be integrally formed as a single piece with the actuator 1400. As shown, the actuator 1400 includes an engagement portion 1404 that is accessible to the user outside the housing 1214 and a shaft 1408 that extends from the engagement portion 1404 into the housing 1214. The lock 1330 is coupled to the shaft 1408. The shaft 1408 extends through and is movable relative to an aperture 1412 in the housing 1214. The biasing mechanism 1334 is positioned between the lock 1330 and the housing 1214. The engagement portion 1404 includes an engagement surface, which is generally arcuate in this embodiment.

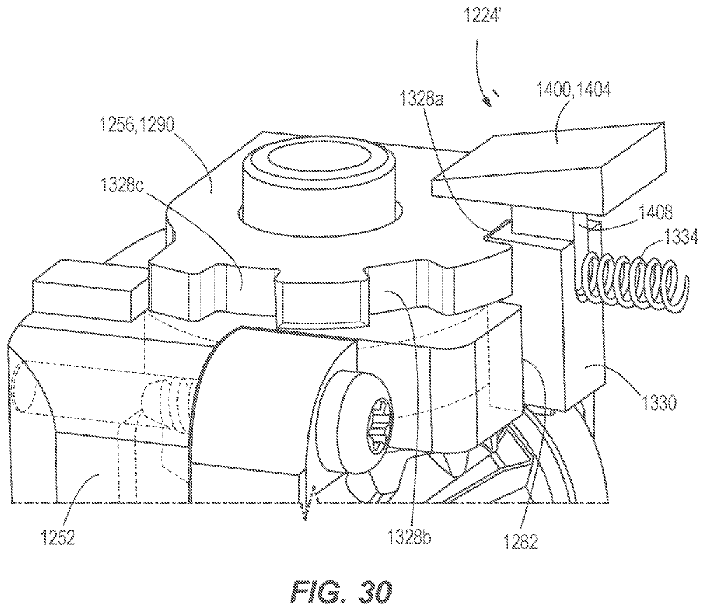

The actuator 1400 is movable along an axis 1416 that is parallel to the axis A1. The lock 1330 is movable between a first position and a second position. In the first position, the lock 1330 is seated within one of the recesses 1328a-1328c of the first leg 1290 of the second support member 1256. In the embodiment of FIG. 29, the lock 1330 is positioned adjacent to the first support member 1252 but not within an opening thereof. In some embodiments, such as FIG. 30, the lock 1330 may also be seated within one of the recesses 1328a-1328c and an opening 1282 of the first leg 1270 of the first support member 1252. Regardless, in the first position, the second support member 1256 cannot move relative to the first member 1252. In the second position, the lock 1330 is spaced apart from the second support member 1256 such that the lock 1330 is not positioned within the recess 1328a-1328c of the first leg 1290 of the second support member 1256. In the second position, the second support member 1256 can move relative to the first support member 1252 because the lock 1330 is spaced apart from the second support member 1256. A force in the direction of arrow 1360 overcomes the bias of the biasing mechanism 1334 to move the lock 1330 from the first position to the second position. When the force is released, the biasing mechanism 1334 automatically moves the lock 1330 from the second position to the first position.

As shown in FIGS. 25 and 31-34, the angled adapter includes a handle assembly 1430. The handle assembly 1430 includes a collar 1434, an extendable handle or arm 1438, a first clamp 1442, and a second clamp 1442. The first clamp 1442 and second clamp 1442 are configured to allow the arm 1438 to telescopically extend and retract to different lengths.

In the illustrated embodiment, the collar 1434 is coupled to and extends about a circumference of the housing 1214.

With respect to FIG. 32, the extendable arm 1438 includes a first end 1450 and a second end 1454 opposite the first end 1450. The first end 1450 is coupled to the collar 1434 and the second end 1454 is spaced apart from the collar 1434. The extendable arm 1438 includes a first arm portion 1460, a second arm portion 1464, and a third arm portion 1468. The portions 1460, 1464, 1468 are movable relative to one another. The first arm portion 1460 has a first end 1480 and a second end 1484 opposite the first end 1480. The first end 1480 of the first arm portion 1460 is also the first end 1450 of the extendable arm 1438. The first arm portion 1460 is configured to be received within an aperture 1488 of the second arm portion 1464. A first bearing 1492 is coupled to the first arm portion 1460 adjacent the second end 1484 and is positioned within the aperture 1488 of the second arm portion 1464. The second arm portion 1464 includes a first end 1500 and a second end 1504 opposite the first end 1500. The second arm portion 1464 is configured to be received within an aperture 1508 of the third arm portion 1468. A second bearing (not shown but like the bearing 1492) is coupled to the second arm portion 1464 adjacent the second end 1504 and is positioned within the aperture 1508 of the third arm portion 1468. The third arm portion 1468 includes a first end 1520 and a second end 1524 opposite the first end 1520. The second end 1524 of the third arm portion 1468 is the second end 1454 of the extendable arm 1438.

The first clamp 1442 has the same components as the second clamp 1442. Therefore, the following discussion of the first clamp 1442 applies to the second clamp 1442. As shown in FIGS. 33 and 34, the first clamp 1442 includes a first clamp portion 1530 and a second clamp portion 1534. The first clamp portion 1530 includes a pair of arms 1540, 1544 that are selectively coupled to one another with a threaded fastener 1548. The fastener 1548 clamps the pair of arms 1540, 1544 together and can selectively increase and decrease the size of a gap 1552 therebetween. The second clamp portion 1534 includes a pair of arms 1560, 1564 that are coupled to another with a threaded fastener 1568. The fastener 1568 clamps the pair of arms 1560, 1564 together and can selectively increase and decrease the size of a gap 1572 therebetween.

As shown, with respect to FIGS. 33 and 34, the first clamp 1442 is coupled to the first arm portion 1460 and the second arm portion 1464. The first clamp portion 1530 of the first clamp 1442 is configured to be coupled to various locations along the length of the first arm portion 1460 and the second clamp portion 1534 of the first clamp 1442 is coupled at or adjacent to the first end 1500 of the second arm portion 1464. The pair of arms 1540, 1544 circumscribe the first arm portion 1460 and are selectively coupled to one another with the threaded fastener 1548. The pair of arms 1560, 1564 circumscribe the second arm portion 1464 and are coupled to another with the threaded fastener 1568.

Similarly, although not shown in detail, the second clamp 1442 is coupled to the second arm portion 1464 and the third arm portion 1468. The first clamp portion 1530 of the second clamp 1442 is configured to be coupled to various locations along the length of the second arm portion 1464 and the second clamp portion 1534 of the second clamp 1442 is coupled at or adjacent to the first end 1500 of the third arm portion 1468. The pair of arms 1540, 1544 circumscribe the second arm portion 1464 and are selectively coupled to one another with the threaded fastener 1548. The pair of arms 1560, 1564 circumscribe the third arm portion 1468 and are coupled to another with the threaded fastener 1568.

In use, the second clamp portion 1534 of the first clamp 1442 is fixedly coupled to the second arm portion 1464, while the first clamp portion 1530 is releasable from the first arm portion 1460 such that the second arm portion 1464 (and therefore the third arm portion 1468 coupled thereto) can slide (with the first clamp 1442) relative to the first arm portion 1460 (and therefore the collar 1434 and the housing 1214). In particular, the threaded fastener 1548 can be rotated in a first direction to increase the gap 1552 between the pair of arms 1540, 1544, which releases the clamping force from the first arm portion 1460, such that the second arm portion 1464 can slide along a length of the first arm portion 1460. Then, once the second arm portion 1464 is appropriately positioned relative to the first arm portion 1460, the threaded fastener 1548 can be rotated in a second, opposite direction to decrease the gap 1552 between the pair of arms 1540, 1544, which causes the arms 1540, 1544 to exert the clamping force on the first arm portion 1460, such that the second arm portion 1464 can be fixed relative to the first arm portion 1460.

Similarly, the second clamp portion 1534 of the second clamp 1442 is fixedly coupled to the third arm portion 1468, while the first clamp portion 1530 is releasable from the second arm portion 1464 such that the third arm portion 1468 can slide (with the second clamp 1442) relative to the second arm portion 1464 (and therefore the first arm portion 1460, the collar 1434, and the housing 1214). In particular, the threaded fastener 1548 can be rotated in a first direction to increase the gap 1552 between the pair of arms 1540, 1544, which releases the clamping force from the second arm portion 1464, such that the third arm portion 1468 can slide along a length of the second arm portion 1464. Then, once the third arm portion 1468 is appropriately positioned relative to the second arm portion 1464, the threaded fastener 1548 can be rotated in a second, opposite direction to decrease the gap 1552 between the pair of arms 1540, 1544, which causes the arms 1540, 1544 to exert the clamping force on the second arm portion 1464, such that the third arm portion 1468 can be fixed relative to the second arm portion 1464.

One or more both of the first clamp 1442 and the second clamp 1442 can be manipulated to adjust the length of the arm 1438. That is, one or more both of the first clamp 1442 and the second clamp 1442 can be manipulated to adjust the position one or both of the second arm portion 1464 and the third arm portion 1468 relative to the first arm portion 1460, the collar 1434, and the housing 1214 to adjust the length of the arm 1438. In other embodiments, there may be only two portions 1460, 1464 and a single clamp 1442 or more than three portions 1460, 1464, 1468 and more than two clamps 1442.

It should be noted that the angled adapters 1210 of FIGS. 19-34 may incorporate the features of the other embodiments discussed herein. Similarly, the other embodiments discussed herein may incorporate one or more of the features discussed with respect to the angled adapters 1210 of FIGS. 19-34.

Although the invention has been described in detail with reference to certain preferred embodiments, variations and modifications exist within the scope and spirit of one or more independent aspects of the invention as described.

Various features and advantages of the invention are set forth in the following claims.

1. An angled adapter for coupling a tool bit to a tool, the angled adapter comprising:
a housing;
a shank supported by the housing, the shank extending along a first axis and including a tool coupling portion configured to couple to the tool;
a tool bit adapter supported by the housing along a second axis, the tool bit adapter being pivotable relative to the housing such that the second axis is disposed at a plurality of angles relative to the first axis; and
a transmission assembly positioned within the housing, the transmission assembly configured to convert an input torque about the first axis from the tool to an output torque about the second axis acting on the tool bit.

2. The angled adapter of claim 1, wherein the transmission assembly includes one or more bevel gears.

3. The angled adapter of claim 1, wherein the plurality of angles range from 75 degrees to 180 degrees.

4. The angled adapter of claim 1, further comprising a lock that maintains the tool bit adapter at one of the plurality of angles.

5. The angled adapter of claim 1, further comprising a first support member that is fixedly coupled to the housing and a second support member that is movably supported by the housing, the first support member supporting the shank, the second support member supporting the tool bit adapter and being pivotable relative to the first support member to a plurality of positions, each of the plurality of positions corresponding to one of the plurality of angles.

6. The angled adapter of claim 5, wherein the transmission assembly includes one or more bevel gears supported by the first support member and one or more bevel gears supported by the second support member.

7. The angled adapter of claim 5, wherein the transmission assembly includes a first bevel gear supported by the first support member and a second bevel gear supported by the second support member, the first bevel gear configured to receive the input torque about the first axis and the second bevel gear configured to generate the output torque about the second axis.

8. The angled adapter of claim 7, wherein the transmission assembly further includes a third bevel gear configured to engage the first bevel gear and a fourth bevel gear configured to engage the second bevel gear, wherein the third bevel gear and the fourth bevel gear are configured to rotate together about a third axis that is perpendicular to the first axis.

9. The angled adapter of claim 8, wherein the third bevel gear and the fourth bevel gear are coupled together by a shaft that extends along the third axis such that rotation of the first bevel gear causes the third bevel gear and the fourth bevel gear to rotate about the third axis, and wherein rotation of the fourth bevel gear causes the second bevel gear to generate the output torque about the second axis.

10. The angled adapter of claim 7, wherein the second bevel gear and the tool bit adapter are formed as a single unitary piece.

11. The angled adapter of claim 5, wherein the tool bit adapter is accessible through a slot in the housing, and wherein the tool bit adapter is movable along the slot to the plurality of angles.

12. The angled adapter of claim 11, further comprising a shield that covers the slot to protect the transmission assembly.

13. The angled adapter of claim 12, wherein the shield is movable with the tool bit adapter.

14. The angled adapter of claim 5, further comprising a lock that maintains the second support member in one of the plurality of positions.

15. The angled adapter of claim 14, wherein
the second support member includes a plurality of recesses, each of the plurality of recesses corresponding to one of the plurality of positions,
the lock is movable between a first position in which the lock is positioned in one of the plurality of recesses and a second position in which the lock is spaced apart from the second support member, and
the lock is biased by a biasing mechanism into the first position and the lock is movable against a bias of the biasing mechanism to move from the first position to the second position.

16. The angled adapter of claim 15, wherein the lock is movable from the first position to the second position along a fourth axis that is parallel to the first axis.

17. The angled adapter of claim 15, wherein the lock is movable from the first position to the second position along a fourth axis that is perpendicular to the first axis.

18. The angled adapter of claim 5, further comprising an extendable handle that is coupled to the housing.

19. The angled adapter of claim 5, further comprising a light that is coupled to the housing.

20. The angled adapter of claim 1, wherein the housing includes a first section and a second section, the first section defining the first axis, the second section defining the second axis and being pivotable relative to the first section to the plurality of angles.

21.-33. (canceled)
